(19) United States
(12) Patent Application Publication
(10) Pub. No.: US 2014/0188675 A1
(43) Pub. Date: Jul. 3, 2014

(54) Expense Calculation and Business Reporting Apparatuses, Methods, and Systems

(71) Applicant: Credit Suisse Securities (USA) LLC, New York, NY (US)

(72) Inventors: Matthew J. Brown, London (GB); Michael Burke, New York, NY (US); Ted Piper, New Providence, NJ (US); Bharat Malesha, East Windsor, NJ (US)

(73) Assignee: Credit Suisse Securities (USA) LLC, New York, NY (US)

(21) Appl. No.: 14/145,485

(22) Filed: Dec. 31, 2013

Related U.S. Application Data
(60) Provisional application No. 61/747,902, filed on Dec. 31, 2012.

(51) Int. Cl. G06Q 40/00

(52) U.S. Cl. CPC G06Q 40/12
USPC 705/30

(57) ABSTRACT

A system for expense calculation, accrual, allocation, and reconciliation, including an expense calculation module configured to receive transaction data relating to a transaction and to apply at least one charge rule to the transaction data to calculate expense data detailing the expenses expected to be charged in association with the transaction; an accounting control module configured to receive the expense data as an input and to apply at least one accounting rule to the expense data to create enhanced data relating to the transaction; and an invoice reconciliation module configured to receive as inputs the expense data as well as invoice data related to the transaction, and to determine whether the invoice data matches the expense data for the transaction.

### CROSS-REFERENCE TO RELATED APPLICATION

This application claims priority under 35 U.S.C. §119 to U.S. Provisional Patent Application No. 61/747,902, filed Dec. 31, 2012, the contents of which are incorporated by reference herein in their entirety.

### FIELD

The present invention is directed generally to apparatuses, methods, and systems for capturing, processing, and managing fees and expenses, particularly, but not limited to, brokerage, clearance, and exchange (BCE) fees. More particularly, the invention is directed to EXPENSE CALCULATION AND BUSINESS REPORTING APPARATUSES, SYSTEMS, AND METHODS (hereinafter EXCALIBUR).

### BACKGROUND

There are myriad variable and fixed fees incurred by market participants in association with executing, clearing, and settling financial transactions. These fees are often known as brokerage, clearing, and exchange (BCE) fees. A broker may charge trade execution fees and other brokerage fees, the exchange may impose exchange fees, regulators may impose regulatory fees, a clearing firm may charge for post-trade expenses related to clearing, and depositories or agent banks may impose settlement charges, and charges for safekeeping.

### BRIEF DESCRIPTION OF THE DRAWINGS

The accompanying drawings illustrate various non-limiting, example, inventive aspects in accordance with the present disclosure:

FIG. 1 shows a conceptual diagram of one embodiment of EXCALIBUR operation;

FIG. 2 shows a schematic illustration of data flows between EXCALIBUR components and affiliated entities in one embodiment of EXCALIBUR operation;

FIG. 3 shows a schematic illustration of data flows between EXCALIBUR components and affiliated entities in another embodiment of EXCALIBUR operation;

FIG. 4 shows examples of brokerage, clearance, and exchange fees that may be incurred in one of many types of transactions that can be handled by EXCALIBUR;

FIG. 5 shows a schematic illustration of an exemplary foreign exchange transaction and some of the fees that might be incurred during such a transaction;

FIG. 6 is a data-flow diagram illustrating an exemplary embodiment of an expense calculation module that may form a part of EXCALIBUR;

FIG. 7 is a data-flow diagram illustrating an exemplary embodiment of an accounting control module 700 that may form a part of EXCALIBUR;

FIG. 8 is a conceptual flow diagram illustrating an exemplary embodiment of the operation of an accounting control module that may form a part of EXCALIBUR;

FIG. 9 is a conceptual flow diagram showing an exemplary embodiment of activity-based allocations that may be effectuated by an accounting control module of EXCALIBUR;

FIG. 10 is a conceptual flow diagram showing an exemplary embodiment of volumetric allocations that may be effectuated by an accounting control module of EXCALIBUR;

FIG. 11 is a conceptual flow diagram showing an exemplary embodiment of fixed allocations that may be effectuated by an accounting control module of EXCALIBUR;

FIG. 12 is a conceptual flow diagram showing an exemplary embodiment of external allocations that may be effectuated by an accounting control module of EXCALIBUR;

FIG. 13 is a data-flow diagram illustrating an exemplary embodiment of an invoice reconciliation module that may form a part of EXCALIBUR.

FIG. 14 is a conceptual flow diagram illustrating an invoice reconciliation and payment process that may be effectuated by an invoice reconciliation module of EXCALIBUR;

FIG. 15 shows a portion of an exemplary embodiment of a user interface for EXCALIBUR;

FIG. 16 shows a portion of an exemplary embodiment of a user interface for an expense calculation module of EXCALIBUR;

FIG. 17 shows a portion of an exemplary embodiment of a user interface for an accounting control module of EXCALIBUR;

FIG. 18 shows a portion of an exemplary embodiment of a user interface for an invoice reconciliation module of EXCALIBUR and in particular the invoice capture function of the user interface;

FIG. 19 shows a portion of an exemplary embodiment of a user interface for an invoice reconciliation module of EXCALIBUR and in particular the reconciliation function of the user interface;

FIG. 20 shows a portion of an exemplary embodiment of a user interface for an invoice reconciliation module of EXCALIBUR and in particular the payment function of the user interface; and

FIG. 21 is a block diagram illustrating exemplary embodiments of an EXCALIBUR controller.

### SUMMARY

In one exemplary embodiment, EXCALIBUR includes a system for expense calculation and management, comprising a processor interfacing with a memory device; an expense calculation module configured to run on the processor, receive transaction data relating to a first transaction, and to apply at least one charge rule to the transaction data to calculate expense data detailing the expenses expected to be charged in association with the first transaction; an invoice reconciliation module configured to run on the processor, receive as inputs the expense data as well as invoice data related to the first transaction, and to determine whether the invoice data matches the expense data for the first transaction; and an accounting control module configured to run on the processor, to receive the expense data as an input and to apply at least one accounting rule to the expense data to create enhanced data relating to the first transaction.

In another exemplary embodiment, EXCALIBUR includes a processor-implemented method for expense calculation, allocation, and reconciliation, the method comprising: receiving, using a processor, transaction data relating to a first transaction; applying at least one charge rule to the transaction data to calculate expense data detailing the expenses expected to be charged in association with the first transaction; receiving the expense data as an input using a processor; applying the at least one accounting rule to the expense data to create enhanced data relating to the first transaction; receiving as input, using a processor, the expense data as well as invoice data related to the first transaction; and determining, using a processor, whether the invoice data matches the expense data for the first transaction.

In another exemplary embodiment, EXCALIBUR includes a machine-readable, non-transitory tangible medium storing processor-issuable instructions to: receive raw data from a plurality of data sources; apply at least one data-quality rule to normalize the raw data and create transaction data; receive transaction data relating to a first transaction; apply at least one charge rule to the transaction data to create expense data detailing the expenses expected to be charged in association with the first transaction; receive the expense data as an input; apply the at least one accounting rule to the expense data to create enhanced data relating to the first transaction; receive as input the expense data as well as invoice data related to the first transaction; and determine whether the invoice data matches the expense data for the first transaction.

In yet another exemplary embodiment, EXCALIBUR includes a system for expense calculation and management, comprising means for receiving transaction data relating to a first transaction; means for applying at least one charge rule to the transaction data to calculate expense data detailing the expenses expected to be charged in association with the first transaction; means for receiving as inputs the expense data as well as invoice data related to the first transaction; means for determining whether the invoice data matches the expense data for the first transaction; means for receiving the expense data as an input; and means for applying at least one accounting rule to the expense data to create enhanced data relating to the first transaction.

### DETAILED DESCRIPTION

### Excalibur

EXCALIBUR is a fully integrated platform for managing the expense lifecycle of brokerage, clearance, exchange, and other fees from accrual to payment. The output produced by EXCALIBUR can be a source of competitive advantage for firms utilizing the system through realization of expense efficiencies and by creating transparency into expense drivers. EXCALIBUR can reduce expense processing costs by centralizing processing and through the retirement of various expense processing systems.

In one exemplary embodiment, EXCALIBUR provides an end-to-end solution for managing brokerage, clearance, and exchange (BCE) fees and may include an enterprise data warehouse of execution-level detail from a plurality of upstream trade capture systems across a plurality of products and regions within a given company, group, or other organization. As used in this disclosure, brokerage, clearance, and exchange (BCE) fees may include all fees associated with any transaction, including regulatory fees, trade-agreement fees, external fees, and any other type of fixed or variable fee. EXCALIBUR may also include a centralized repository of rate schedules across all brokers, exchanges, agent banks, and other industry utilities that generate brokerage, clearing, and exchange expenses. EXCALIBUR may include a highly configurable rules-based calculation engine capable of calculating complex fees across a diverse set of vendors, rate schedules, and expense types. It may also include the ability to automate monthly accrual processes and provide an integrated solution for invoice validation and payment. It may also have flexible business-intelligence-reporting capabilities. Although EXCALIBUR can provide a technology platform well-suited for major banks, buy-side firms and financial software vendors, EXCALIBUR may also be used by any other business, organization, group, or individual with a need to capture, track, and manage any type of fees or other expenses.

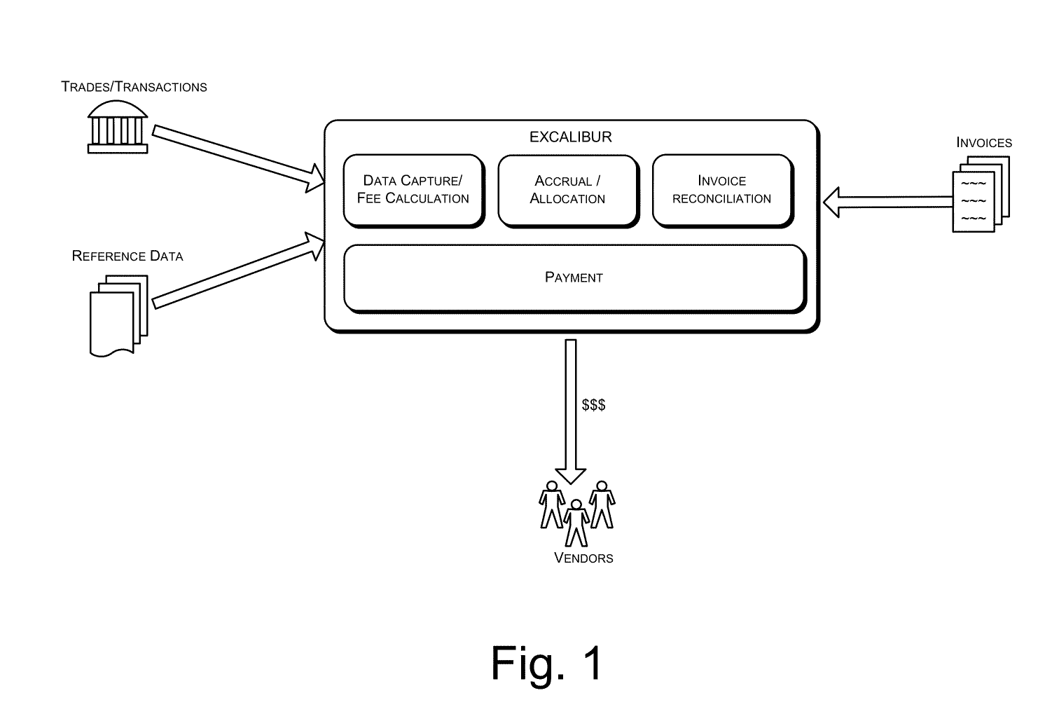

As shown in FIG. 1, in one exemplary embodiment, EXCALIBUR may include four major components that serve the needs of users throughout the expense lifecycle: a data capture and fee calculation component, an accrual/allocation component, an invoice reconciliation component, and a payment component.

The data capture and fee calculation component may calculate BCE fees and calculate expenses at an individual transaction level based on actual service utilization using the transaction details and reference data which constitute pricing inputs into a BCE vendor's service offerings. This enriched transactional record may be captured in a BCE data warehouse for identification, quantification, and validation of expense savings initiatives. The enriched transactional record from the data capture component may also enable measurement of trading profits and losses net of BCE expenses. The data capture and fee calculation component may also serve to provide a rate feed to external clients and support client billing of trading and other BCE costs.

The accrual/allocation component may ensure that accruals are systematically posted to the ledger based on the calculated fees on the enriched transactional record, based on an estimate using the historical actual fees, or based on a recurring fixed amount. It may improve the accuracy of allocations of expenses to individual business lines within an organization by basing the fee allocation on observations of actual service utilization. It may also provide an internally calculated fee record which can be used to independently verify fees charged by brokers, market centers, and other service providers.

The invoice reconciliation component may be configured to directly receive invoices in digital format from a vendor, scan paper invoices and perform an optical character recognition process to extract pertinent information from an invoice, to receive invoice information entered manually or by any other means. Once an invoice has been captured, the invoice reconciliation component may be configured to match the data taken from an invoice with data for a transaction stored by the data capture and calculation component. The invoice reconciliation component may also be configured to identify and delineate the impact of accounting adjustments. The invoice reconciliation component may also help to identify savings opportunities by identifying overbillings and ensuring that vendors conform to agreed-upon rates. If discrepancies exist between the data gleaned from an invoice and the data relating to a given transaction, the invoice reconciliation component may be configured to remedy the problem or to send a request to appropriate personnel so that the problem can be remedied.

The payment component may be configured to automatically submit payment to a vendor or service provider once an invoice has been reconciled. The payment component may also automate the authorization and posting to the general ledger system of invoice payments.

EXCALIBUR serves to lower information technology operating expenses by consolidating BCE fee capture, calculation, allocation, and reconciliation from multiple data sources. EXCALIBUR also provides greater efficiency when compared to previous systems by eliminating manual accounting tasks and thus reducing labor costs and errors.

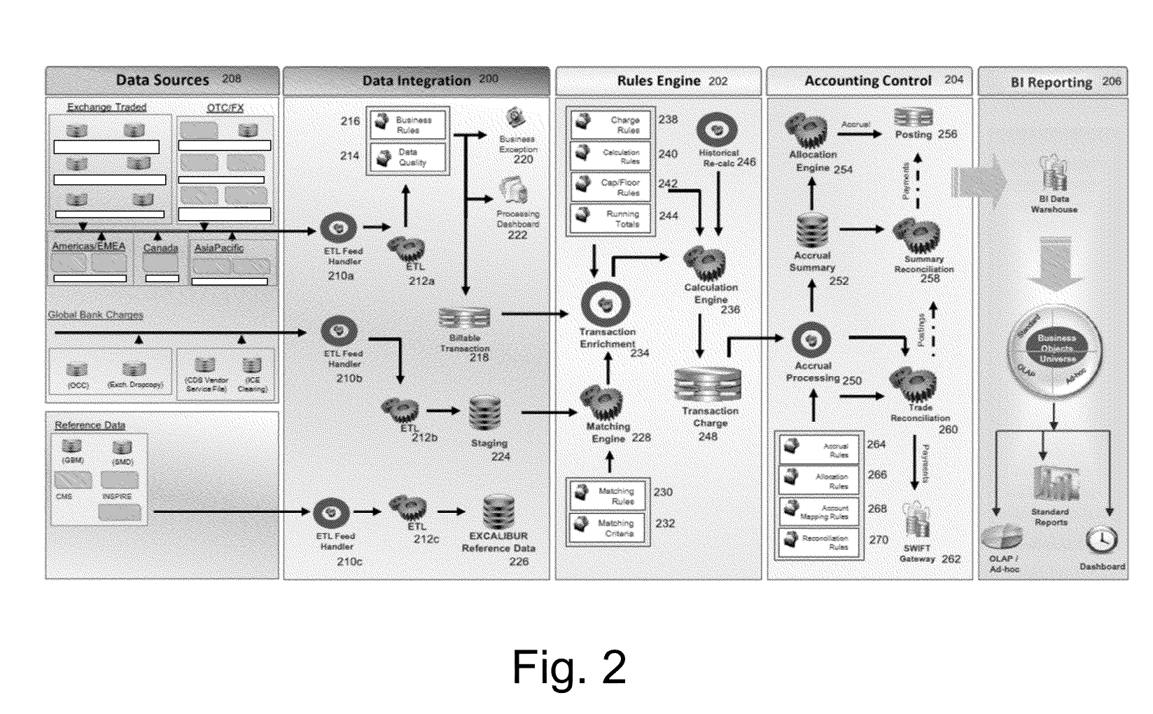

FIG. 2 is a schematic representation showing one exemplary embodiment for carrying out data capture and fee calculation, accrual and allocation, invoice reconciliation, and payment using EXCALIBUR. In the exemplary embodiment shown, EXCALIBUR includes a data integration component 200, a rules engine component 202, an accounting control component 204, and a business intelligence component 206. One or more of these components may exchange data with a plurality of internal and external data sources 208. In one exemplary embodiment, the EXCALIBUR components interact with more than one hundred internal and external data feeds, are able to process hundreds of millions of transactions per month, and are capable of calculating over one hundred million transactions after compression based on billable attributes.

As shown in FIG. 2, data integration component 200 may include a plurality of extract, transform, and load (ETL) feed handlers 210 (for example, ETL feed handlers 210a, 210b, and 210C shown in FIG. 2) configured to extract data from one or more of data sources 208. The data is then passed from ETL feed handlers 210 to one or more ETL modules 212, such as ETL modules 212a, 212b, and 212C shown in FIG. 2. ETL modules 212 may be configured to apply a series of rules or functions to the extracted data to derive data that can be passed on to rules engine 202 or used to populate various internal databases within EXCALIBUR. ETL modules 212 may be configured to perform validation and further enrichment of the data, and to load the data into source data tables that can then be used by other components of EXCALIBUR. ETL modules 212 may perform data normalization, which includes cross-product data capture, standardization, and enrichment; and transaction-level matching with external data to enable enrichment of attributes from external data. ETL modules 212 may also merge several source feeds to generate enriched transactions with the required billable attributes. ETL modules 212 may also perform data validation, which includes validation of the required attributes and elements specific to a product, and integration into a unified exception framework that enables review and processing of exceptions.

ETL modules 212 may also perform data enrichment, which may include creating user-defined dynamic mappings specific to the source of the data, dynamically resolving the codes from the source using a common framework across various financial instruments, and determining the eligibility of the transaction for volume consideration. ETL modules 212 may also perform cancel and correction processing, which may include processing transaction amendments and cancellation, adjusting transaction volumes, and de-activating charges on cancelled or older transactions.

In one exemplary embodiment, ETL feed handler 210a receives a plurality of data feeds from a plurality of data sources 208. As shown in FIG. 2, ETL feed handler 210a may receive a plurality of data feeds, which are then passed to ETL module 212a, where the data undergoes a data quality check 214 and a business rules check 216 to standardize the data, after which the data is stored in a billable transaction database 218. Data sent from ETL module 212a may also be passed to a business exception module 220 and a processing dashboard module 222. As shown in FIG. 2, ETL feed handler 210b and ETL module 212b may process data that is then stored in a staging database 224 before being passed to rules engine component 202. Similarly, ETL feed handler 210C and ETL module 212C may process data received from various data stores and store that data within an EXCALIBUR reference database 226.

In one exemplary embodiment, staging database 224 is a temporary holding area for the data before it is loaded into rules engine component 202. Data from staging database 224 may then be sent to matching engine 228 within rules engine component 202. In one embodiment, matching engine 228 is a flexible and highly scalable rules-driven matching engine configured to systematically match trade facts with external trade data and internal records. The matching engine may implement matching rules 230 and matching criteria 232. Each matching rule 230 may be specific to a product and additional conditions defined as a basis for the rule. The input state and output state of the transaction may be configurable for each rule. Matching engine 228 may allow multiple passes starting with stringent matching criteria and moving to less stringent matching criteria. Matching engine 228 may allow for one-to-one, one-to-many, and many-to-many matches. Matching rules 230 may include a transaction scope that is fully configurable in the rule, and the matching attributes may be fully configurable in each rule and for each iteration. In one exemplary embodiment, the matching attributes may support regular Oracle functions and expressions.

After data has been transformed by matching engine 228, the data may then be passed to a transaction enrichment module 234. Standardized data stored in billable transaction database 218 may also be passed to transaction enrichment module 234. In one embodiment, transaction enrichment module may create user-defined dynamic mappings specific to the source of the data, dynamically resolve the codes from the source using a common framework across various financial instruments, and determine the eligibility of the transaction for volume consideration.

The data may then be passed to calculation engine 236. In one exemplary embodiment, calculation of a single transaction may start with a transaction object passed from transaction enrichment module 234. The transaction object may represent a unified, non-product specific interface which is being used throughout the calculation process. Calculation engine 236 may use reflection to identify rules applicable to the transaction to be calculated. A plurality of rules may be implemented by calculation engine 236 during the calculation process, including charge rules 238, calculation rules 240, cap/floor rules 242, and running totals rule 244, as shown in FIG. 2. Each rule may have a basis. The basis may be an attribute name and an attribute value pair. Using reflection on a transaction object and rule bases, calculation engine 236 may identify which rules are applicable to each transaction. In addition, further flexibility may be achieved through assigning priority values to each transaction rule.

In one exemplary embodiment, charge rules 238 are rules-based definitions of applicable charges for each transaction. Charge rules 238 may be stored in a charge rule table that identifies the set of charges that must be calculated for a given transaction. In the charge rule table, charge rules 238 may be set up based on the product type and product sub type. The criteria for the charge rules 238 may be defined in a charge rule basis table. The charge rule basis table defines the rules that need to be applied to a transaction to determine the applicable charges for a charge rule 238. In one exemplary embodiment, the criterion may be represented in the form of a name-value pair, also known as a key-value pair. Each charge rule 238 may be based on a combination of one or more attributes such as account type (customer, firm), firm role (executing, clearing), trade side (buy/sell), business event, and transaction event. For example, a charge rule 238 defined as a broker fee may have the following attributes: rule id=3, productType=FXCash, priority=100, with the following bases (AttributeName/AttributeValue pairs): DealType=Direct Counterparty, Brokerld=43212, BrokerID=43223. In this example, the charge rule 238 is applicable to FXCash product transactions for brokers 43212 or 43223 when dealing with a direct counterparty. In determining the applicability of a rule, calculation engine 236 may also look to the priority value. In one embodiment, when multiple rules apply to a transaction, the rule with the highest priority is selected and applied to the transaction.

When applicable charge rules have been identified, calculation engine 236 may then select the highest priority calculation rules applicable to the charges to be calculated. Calculation rules 240 may include a set of criteria to determine rate schedule and to determine a value to which the rate is applied for calculating a specified charge. Calculation rules 240 may be set up as a combination of product type/subtype and charge type/subtype. A calculation rules basis may be used to define the criteria that need to be applied to a transaction to determine a rate to be applied to a given calculation rule 240. The criteria may be represented in the form of a name-value pair. Calculation rules 240 may be based on a combination of one or more attributes, such as broker identifier, exchange identifier, execution method, trading location, liquidity behavior, deal currency, and region.

After calculation engine 236 has determined the rate to be applied to a given transaction, a calculated rate schedule object may be created and all the relevant calculations may be stored in the object including current running total value used for the calculation, tier discount, exchange rates, base rate, calculation rule used, and rate schedule.

For each transaction, calculation engine 236 may also apply cap/floor rules 242. Using these rules, calculation engine 236 may determine if any limits apply to a given transaction. A cap may be applied if the calculated value is greater than a given limit, while a floor may be applied if the calculated value is smaller than the value of the floor. Cap/floor rules 242 may be set up in a manner similar to the set up of the calculation rules 240. Cap/floor rules 242 may be loosely coupled by product, charge, and party. The criteria for applying a cap or floor can be independent of the actual rate applied. Calculation engine 236 may support transaction-level limits, monthly charge limits, daily charge limits, limits based on volume, and any other suitable limit. Cap/floor rules 242 provide transparency as to the amount of discount applied to the transaction based on limits. A transaction may potentially be subject to one or more limits. For example, a transaction may have a limit per transaction charge and a percentage discount after a specific monthly limit on the volume. As an example, an organization may have a $75,000 per-month cap for charges to firm accounts in equity, exchange traded fund shares, and trust issued receipt and index option transactions.

Running totals rule 244 may be stored in a running totals table that maintains daily and monthly transactional running totals for comparison of limits and tiers. Running totals rule 244 may include a running totals basis table, which serves to capture daily and month-to-date summarization of various charges and sub-charges for a given set of attributes.

Calculation engine 236 may also interface with historical recalculation engine 246. While calculation engine 236 calculates charges for the current business data transactions, historical recalculation engine 246 may perform calculations on historical data. Any changes to rates, rules, limits, or running totals which are effective between the first business day of the month and the current business date, may be eligible for historical calculations. If any historical recalculations are to be performed outside these dates, the transactions may need to be populated in a recalculation request table. Historical recalculation engine 246 may calculate charges of transactions in the recalculation request table with a flag indicating that the request has not been completed. When any rule, rate, limit, or running total changes for a given party, charges may be calculated for all transactions of that party. After transactions have been processed by matching engine 228 and calculation engine 236, the transaction data may be stored in a transaction charge database 248 before being passed to accounting control component 204.

In one exemplary embodiment, accounting control component 204 may include an accrual processing module 250, an accrual summary database 252, an allocation engine 254, a posting database 256, a summary reconciliation engine 258, and a trade reconciliation engine 260. In one exemplary embodiment, transaction data stored in transaction charge database 248 is passed to accrual processing module 250, where various rules may be applied to the data, including accrual rules 264, allocation rules 266, account mapping rules 268, and reconciliation rules 270. In one exemplary embodiment EXCALIBUR may also include a payment module with a SWIFT (Society for the Worldwide Interbank Financial Telecommunication) gateway 262.

These modules may provide a centralized and controlled process for accrual, allocation, and posting of BCE expenses. Accrual processing module 250 and allocation engine 254 may create month-end accrual summaries upon which a rules-driven posting engine can process the accruals at the end of each accounting period. Allocation rules and schedules may be provided, along with the ability to override and remap specified departments using remap schedules to re-allocate expenses systematically. The modules within accounting control component 103 may provide control, transparency, and oversight to an expense line controller or other user managing postings to the expense lines before the expense is released to the general ledger system. The modules may allow for manual adjustments to the accrual and proper allocation and authorization of the adjustments. The manual accrual processing feature gives a user the flexibility to upload accruals for any financial product and expense line and the ability to carefully review the magnitude and allocation of the fees prior to authorization. The modules may provide pre-defined templates by financial product type for preparation and recording of manual accruals.

Summary reconciliation engine 258 may function to auto-reconcile billable events and charges versus the accrual summary at the invoice line-item, it may provide a tool set to investigate variances, it may auto-adjust the accruals where the accruals are within an adjustment threshold, it may capture manual accruals in the case where the accrual is missing, it may set up charges when they first occur, and it may allow a user to sign off on adjustments over the threshold. Trade reconciliation engine 260 may function to automatically match trade facts so that each trade is automatically reconciled.

Business intelligence component 206 may allow a user to create and view various reports relating to tracked expenses and fees. Business intelligence component 206 may also access a common data repository of historical expenses at the trade or summary level and may capture various cost and volume dimensions to populate predetermined and ad-hoc reports. Business intelligence component 206 may include reports with rate and volume analysis, exchange fee reporting and effective rate analysis. Business intelligence component 206 may also consolidate manual reports, provide accrual variance reporting, and provide for tracking and reporting of unpaid accounts.

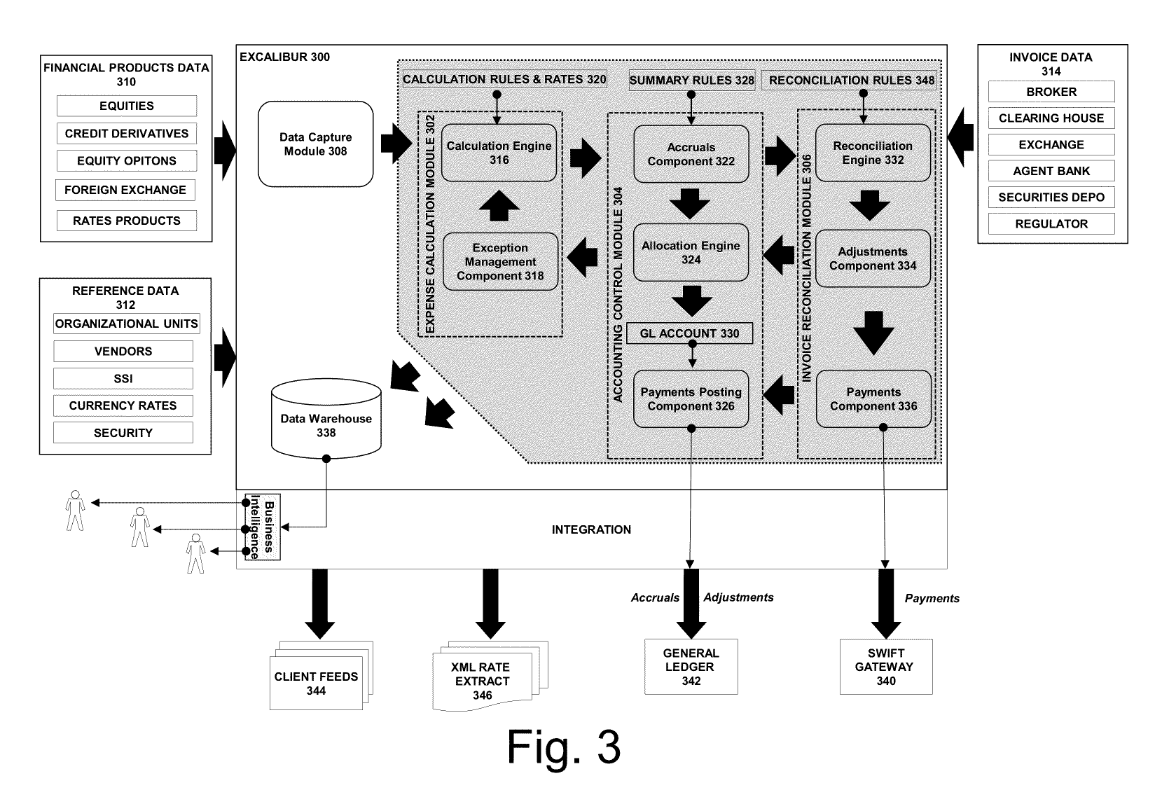

FIG. 3 shows another exemplary embodiment of EXCALIBUR, including three modules: expense calculation module 302, accounting control module 304, and invoice reconciliation module 306. Although each of these modules may exchange data and work together within EXCALIBUR, each module may also be used independently, that is, each module is also capable of receiving data from other sources outside of EXCALIBUR.

EXCALIBUR can be adapted for use in any business or organization with a need to calculate, track, and pay expenses. However, the exemplary embodiment shown in FIG. 3 is focused on the application of EXCALIBUR to a financial services firm, and particularly to address the needs of a financial services firm during the three primary phases of a security trade lifecycle: execution, clearing, and settlement. The execution phase of the security trade lifecycle involves various vendors, which could include brokers, traders, exchanges, alternative trading systems, multilateral trading facilities, crossing networks, and electronic communication networks (ECNs), among others. For example, a financial services firm, such as a broker/dealer, might want to purchase a certain number of shares in the stock of a company trading on the New York Stock Exchange. That broker/dealer may enlist a broker to purchase shares on the stock exchange, if the broker/dealer is not a member of the exchange, to execute the transaction. The broker/dealer may send the order directly to the New York Stock Exchange for execution if the broker/dealer is a member of the exchange. The clearance step of the security trade lifecycle is usually handled by a clearing house—an organization that aggregates transactions and guarantees settlement of the transactions. Settlement is usually handled by agent banks and depositories, which keep records of, and effect the change in ownership of securities

The exemplary embodiment of EXCALIBUR shown in FIG. 3 is a straight-through processing platform for all transaction expenses that might be incurred by a financial services firm. Straight-through processing means that EXCALIBUR can process an expense through the entire expense lifecycle with minimal or no intervention from a user. The expense lifecycle generally includes six phases: calculation, allocation, accrual, reconciliation, adjustment, and payment.

During the calculation phase, a financial services firm, such as an investment bank, generates a transaction on its records that replicates the cost the bank expects a vendor to bill the bank at the end of an accounting period. During the allocation phase, the bank identifies the businesses within the bank that have used the services provided by the vendor. In some cases, the vendor may provide dozens or even hundreds of services to the bank all with varying prices. The bank may have hundreds or even thousands of businesses that use the services of that vendor. During the accrual phase, expenses are summarized and reviewed against the historical record of expense accruals from prior business periods, by way of example, but without limitation, on an absolute or moving-average basis. Upon approval, these expenses are released to the general ledger system and constitute the financial records of the bank until such time as the invoice is received from the vendor.

During the reconciliation phase, the bank takes a vendor invoice, identifies the services that the vendor is billing the bank for, captures the billable volume and per-unit price of each line item, and compares that captured record with the internal record at the bank to find any variance between the vendor invoice and its internal records. When a variance is found, investigation with the vendor may be initiated and/or adjustments may be made during the adjustment phase. These adjustments, if any, are also reflected in the general ledger system of the bank. After all of these steps have been completed, the payment phase is initiated to actually disperse funds to the vendor to satisfy the invoice.

The exemplary embodiment of EXCALIBUR shown in FIG. 3 automates and integrates each of these steps in the expense lifecycle. Expense calculation module 302, accounting control module 304, and invoice reconciliation module 306 may each interface with one another and with a data capture module 308, which serves to capture, validate, and enrich data received from various sources, including financial products data 310, reference data 312, and invoice data 314. Financial products data 310 may include data regarding equities, credit derivatives, equity options, foreign exchange transactions, and rates products, as well as any other financial product or service. Reference data 312 may include data regarding vendors, organizational units, standard settlement instructions (SSI), currency rates, and securities and all other suitable data. Invoice data may include data from brokers, clearing houses, exchanges, agent banks, security depositories, regulators, and others.

Expense calculation module 302 may include a calculation engine 316 and an exception management component 318, and may include one or more databases with calculation rules and rates 320. Accounting control module 304 may include an accruals component 322, an allocation engine 324, and a payment posting component 326. The accounting control module may send and receive data from various sources, including data relating to summary rules 328 and a general ledger account 330. Invoice reconciliation module 306 may include a reconciliation engine 332, an adjustments component, 334, and a payment component 336. The data received and generated by each of the modules and components may be stored in an expense data warehouse 338, which may be housed in one or more databases.

As shown in FIG. 3, EXCALIBUR may also include an integration component, which allows the system to interface with outside system such a SWIFT gateway 340 and a general ledger system 342 of a bank or other financial institution. EXCALIBUR may also be configured to provide client feeds 344 and XML rate extract capabilities 346. In one exemplary embodiment, EXCALIBUR may be configured to provide business intelligence data and other data feeds to customers or other third parties.

Brokerage, clearing, and exchange (BCE) fees is a general term used to describe the fees incurred during the securities trade lifecycle. In addition to fees incurred for brokerage, clearance, and exchange, BCE fees may also refer to other variable and fixed fees incurred during the trade lifecycle, including regulatory fees, trade agreement fees, and any other fixed or variable fees.

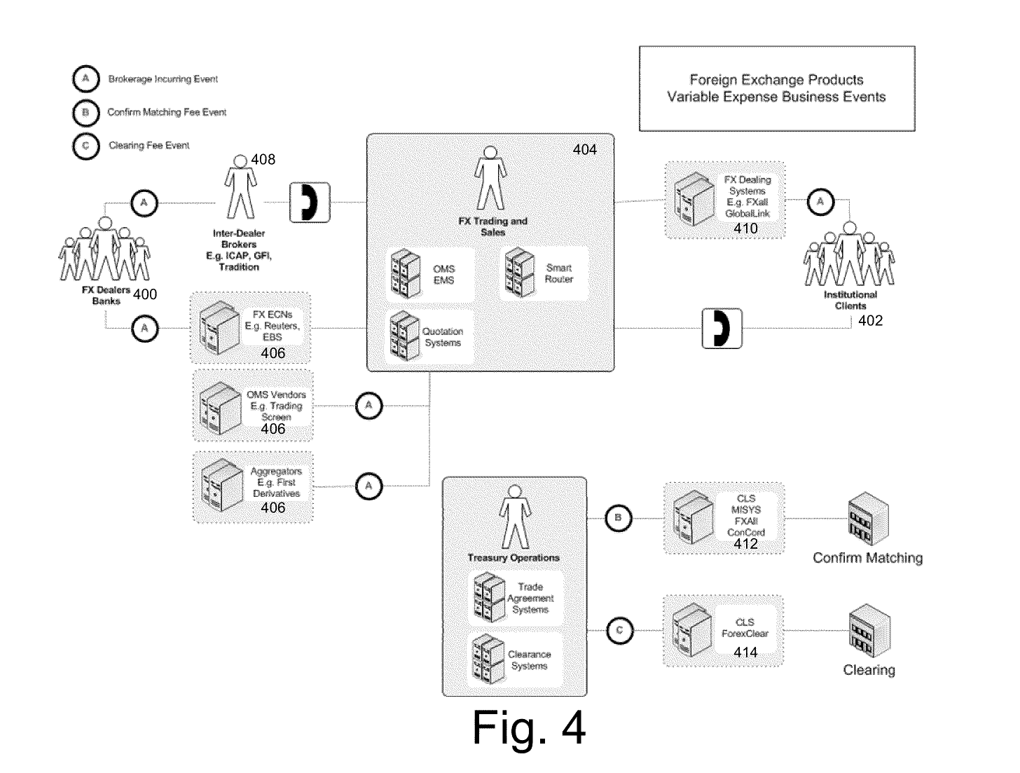

FIG. 4 shows examples of BCE fees that may be incurred in one of the many types of transactions that can be handled by EXCALIBUR—a foreign exchange transaction. In a typical foreign exchange transaction, a bank 400 or other foreign exchange dealer will interact with an institutional client 402 (a corporation, a pension fund, an asset manager, etc.) who has asked the bank to take the other side of the currency transaction. Bank 400 may have a foreign exchange (FX) trading and sales system 404 directly wired to the vendor community, both on the wholesale, interdealer side of the market and on the institutional side of the market. For example, FX trading and sales system 404 may be directly connected to electronic execution systems 406, which may operate like exchanges or simply allow the bank to post two-sided quotes onto different aggregation engines or order management systems. Bank 400 may also deal with an inter-dealer broker 408, who may execute transactions electronically or by phone. Whether bank uses inter-dealer broker 408 or the electronic executions systems 406, it will incur a brokerage fee when the trade is executed. This brokerage incurring event is labeled “A” on FIG. 4. A brokerage fee may also be triggered if bank 400 uses an electronic FX dealing system 410, such as FX Alliance, to find a counterparty for a foreign exchange transaction.

Additionally, once a trade has been executed, there are additional fees associated with back-end functions, including confirm matching fees charged by a confirm companies 412 such as CLS, MISYS, FX Alliance, or ConCord, and a clearing fee charged by a clearing house 414 such as Continuous Link Settlement (CLS) or ForexClear, which stands in the middle of a transaction, aggregates volume or the different market participants, and guarantees settlement. The confirm matching event is labeled “B” in FIG. 4, and the clearing fee event is labeled “C.” EXCALIBUR may be configured to handle all of these fees, from accrual to payment.

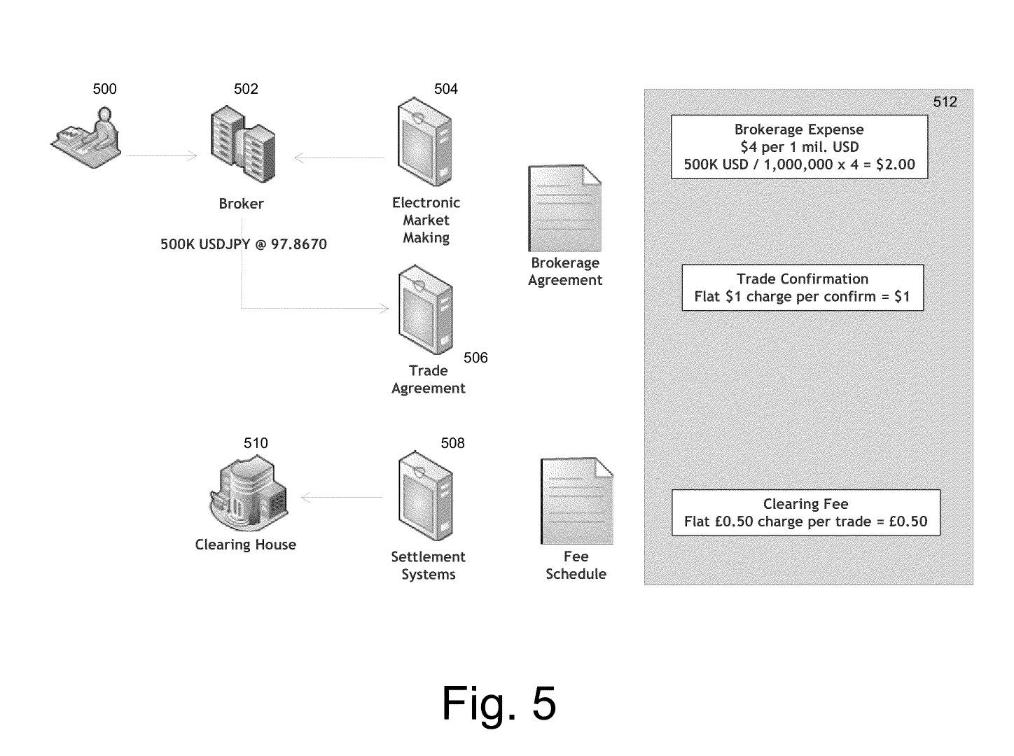

FIG. 5 shows an example foreign exchange transaction and some of the BCE fees that might be incurred during such a transaction and that can be handled by EXCALIBUR. In the example, a bank or other institution is selling 500,000 US dollars and buying the equivalent amount of Japanese Yen. The dollar-to-yen rate on the transaction is 970.8670. As shown in the figure, an institutional investor 500 indicates through an electronic dealer network or other broker 502, its desire to purchase 500,000 USD. A bank provides a quote 504 to the electronic dealer network or broker 502, against which the investor's request is executed. Dealer network 502 then generates out an electronic confirm or trade agreement message 506, and the transaction is eventually transmitted from the bank's settlement system 508 to a clearing house 510 for settlement. The BCE fees associated with this transaction are shown at 512. First, the electronic dealer may charge a variable brokerage fee of $2.00 for this transaction, based on a rate spelled out in the brokerage agreement of $4 per million USD. The trade confirmation fee shown is a flat fee of $1, and the clearing fee shown is a flat charge of 0.50 pounds (or 50 p) per trade.

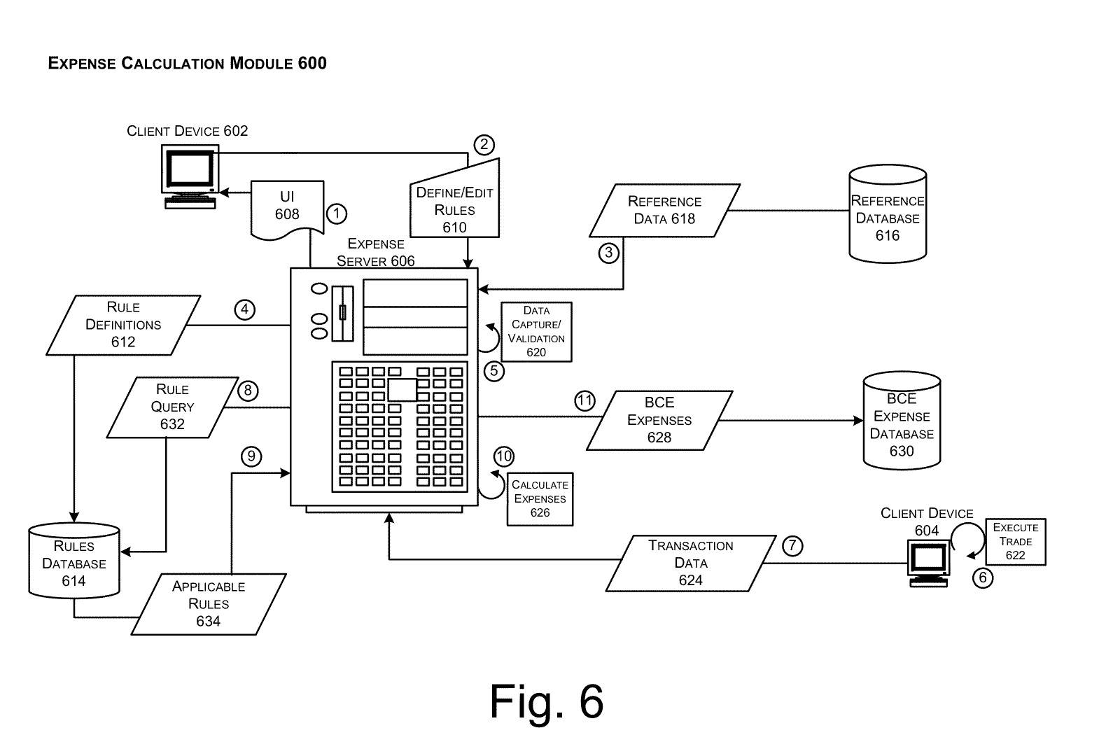

FIG. 6 is a data flow diagram illustrating an exemplary embodiment of an expense calculation module 600 that may form a part of EXCALIBUR. Expense calculation module 600 may be implemented using any suitable combination of hardware and software. In one exemplary embodiment, expense calculation module 600 includes a user interface, allowing a user to access data and input and change expense calculation rules. Expense calculation module 600 may also interface directly with third-party systems without human intervention. Although FIG. 6 depicts the interactions between a client device 602, a client device 604, and an expense server 606, a variety of other components and configurations may be used by EXCALIBUR during operation. Expense server 606 may be a plurality of servers, each with a specific function, or with multiple functions. Likewise, user devices 602 and 604 may be any suitable device that allows a user to connect to other devices and databases through a network. Although only two client devices are shown, it should be understood that expense calculation module 600 may be configured to interface with a large number of client devices simultaneously. The network may be the internet, a wide-area network, one or more intranets, one or more extranets, or any other suitable computer network. Examples of suitable client devices include, but are not limited to, a laptop computer, a desktop computer, a tablet computer, and a smart phone. The various databases depicted may also be one or databases interfacing with other devices through any suitable network.

As shown in FIG. 6, a client device 602 may send a request to expense server 606, and be configured to access expense server 606 through a user interface 608. In one exemplary embodiment, user interface 608 is a graphical user interface with a series of drop-down menus, radio buttons, text fields, and/or any other suitable elements for aiding a user in interacting with expense calculation module 600. A user may input data and define or edit expense calculation rules 610 through user interface 608. Upon receiving rule definitions through user input 610, expense server 606 may store rule definitions 612 in a rules database 614. Rule definitions 612 may also be derived from other external sources.

In one exemplary embodiment, a user accessing user interface 608 is able to define data that exists upstream of EXCALIBUR, from external data feeds. Information can be defined in EXCALIBUR and extracted and then standardized in one framework by a user into a standard input that can be read by an expense calculation engine that forms part of expense calculation module 600. In one exemplary embodiment, expense calculation module may include a plurality of mappings using key-value pairs, which allows EXCALIBUR to integrate different heterogeneous sets of data into one homogenous record that conforms to a standard definition. This standard definition can then be used by an expense calculator within expense calculation module 600.

For example, a user may be able to define all the rules applicable to a transaction to determine which expenses need to be applied to that transaction. These rules may reflect different rate schedules and agreements a financial institution using EXCALIBUR may have with its vendor community. In one exemplary embodiment, this can be accomplished by creating or editing key-value pairs in the expense calculation module 600. In a key-value pair, the key is a unique field name, and the value is the content of that field, or in other words, the data being stored. Using key-value pairs to define the attributes for each fee associated with a transaction provides an extensible framework for EXCALIBUR.

Expense calculation module 600 is able to gather data from source systems containing all of the input needed to price the services provided by outside vendors. This data can be transactional data, but can also include orders, executions, lists of registered users, or any other type of structured data. The fee structure for a given vendor can then be replicated and the ultimate charges expected from the vendor can be determined. When new criteria for a given transaction are required, a user can simply add those criteria to the definition of the attributes for the fee associated with a given transaction. In other words, the framework can be extended to handle new scenarios without having to introduce a code change. This key-value pair architecture also makes EXCALIBUR scalable. Although the expense calculation module 600 may be configured to allow an individual user to enter and edit rules applicable to transactions through user interface 608, expense calculation module 600 may also be configured to automatically receive and process data feeds from external sources. Expense calculation module 600 may also be configured to parse these data feeds to create key-value pairs applicable to thousands of transactions.

In one exemplary embodiment, EXCALIBUR may receive a plurality of data feeds, which are then used by each of its modules, including expense calculation module 600. For example, EXCALIBUR may receive more than one hundred external data feeds from all types of vendors and service providers. These outside feeds provide information regarding transactions that may be processed by EXCALIBUR, including information about organizational units, vendors, securities, standard settlement instructions, currency rates, accounting information, organizational unit structure, trading account information for a firm, information about every type of security traded by a firm, and any other information that might be useful for calculation, accrual, allocation, accounting, and payment purposes.

As shown in FIG. 6, expense server 606 of expense calculation module 600 may interface with reference database 616 to receive a feed of reference data 618. Reference data 618 may be received as a continuous data feed or may be received intermittently as data becomes available. Although only one database and one data feed is shown in the figure, it should be understood that expense calculation module 600, and EXCALIBUR in general, are capable of receiving and processing hundreds of data feeds simultaneously.

Once expense server 606 has received data feed 618, expense server 606 may initiate a data capture and validation process 620. This process may be used to validate and enrich the data, and to load the data into source data tables in rules database 614 or other databases. The data may then be made available for use by other modules and components of EXCALIBUR. Expense server 606 may include a plurality of extract, transform, and load (ETL) feed handlers configured to perform data normalization, including cross-product data capture, standardization, and enrichment. Expense server 606 may also provide transaction-level matching with external data to enable enrichment of attributes from external data. Expense server 606 may also merge several source feeds to generate enriched transactions with the required billable attributes. The data capture and validation process 620 may also include validating the required attributes and elements specific to a product, and integration of the data into a unified exception framework that enables review and processing of exceptions. During this process, data from external feeds is received in a format that allows expense calculation module 600 to understand where the data came from and how it was transmitted. Expense server 606 then resolves the data into a standard form that can then be used in expense calculation module 600 and throughout EXCALIBUR.

Expense calculation module 600 is also capable of receiving transaction data from external data sources such as trading desks or expense departments at a company or organization, such as a bank or other financial institution. As shown in FIG. 6, a client device 604 may execute a transaction 622 on an exchange, an ECN, or through some other suitable means. Once the transaction has been executed, transaction data 624 is transmitted from client device 604 to expense server 606. Upon receiving transaction data 624, expense server 606 may then initiate an expense calculation process 626. In one exemplary embodiment, expense calculation process 626 is effectuated by an expense calculation engine running on expense server 606.

The expense calculation engine may be configured to calculate variable expenses for all costs associated with a financial transaction. For each transaction processed by expense calculation module 600, the expense calculation engine may be configured to take the rules stored in rules database 616 and determine which expenses should be applied to the transaction. For example, for a foreign exchange cash transaction, a calculation engine running on expense server 606 would receive transaction data 624 from an external client device 604, as well as other reference data 618 from one or more reference databases 616. Expense server 606 would then send a query 632 to rules database 614 requesting the rules that are applicable to the foreign exchange cash transaction. In response to this query, rules database 614 would send the applicable rules 634 to expense server 606, which would then use the calculation engine to determine the fees that should be applied to the transaction.

In one exemplary embodiment, the applicable rules 634 would be sent to expense server 606 as a flat file containing key-value pairs, in the following format:

ConfirmMatchingInd: Y

DealType: InterCompany

DealType: Direct Counterparty

DealType: Allocation

DealType: Street

In this example, the file sent to expense server 606 indicates when a particular fee should be applied to a particular transaction from a particular vendor. When the key-value pair attributes are satisfied, expense calculation module 600 may be configured to raise a brokerage fee, a clearance fee, an exchange fee, or any other applicable fee. The rules are formatted as key-value pairs, which contain both an attribute and a value. By layering a series of key-value pairs together, a criteria can be built for determining when a rule should be applied. For example, the key-value pairs shown above may be associated with a vendor, such as FX Alliance, and a brokerage fee. When a transaction involving FX Alliance is received by expense calculation module 600, and when all of the values of the key-value pair match, a specified fee will be applied to that transaction.

In one exemplary embodiment, when there are multiple instances of the same attribute, the key-value pair containing that attribute is treated as an OR condition. In other words, in the example given above, the fee would be applied when the confirm matching indicator is Yes and if the deal type is any one of inter-company, direct counterparty, allocation, or street.

A particular transaction can have any number of fees associated with that transaction, and the rules and their key-value pairs will determine which fees apply to the transaction. In one exemplary embodiment, the rules stored in rules database 614 are not mutually exclusive, meaning that more than one rule can apply. If there is a conflict between one or more rules, a priority value may be used to determine which rule applies. In one exemplary embodiment, each rule includes a priority value, and the when a conflict between two rules arises, the rule with the higher priority value will be applied in determining the fees to apply to the transaction. If the priority values for the conflicting rules are the same, expense calculation module 600 may be configured to throw an exception. In one exemplary embodiment, such an exception would require intervention from a user to resolve the priority conflict and reprocess the exception.

Expense calculation engine may calculate a plurality of rules during the calculation process. For example, rules may include charge rules, calculation rules, limit rules, and running total rules. Each rule may include a key-value pair that includes attribute name and attribute value. Again, providing two rules with the same name may be used as an OR condition. To identify if a rule is applicable, the calculation engine may evaluate which of the two rules has the highest priority. In one exemplary embodiment, calculation rules may be defined for daily and monthly calculations.

Expense calculation module 600 may also be configured to handle discounts, for example, a 50% volume discount once a customer exceeds $100,000 in brokerage fees for any calendar month. This type of incentive structure may be handled using limit rules. Limit rules can be based on a volume criteria—keeping track of volume of transactions with a particular vendor during a particular period. Expense calculation module 600 may keep track of running totals for month-to-date or year-to-date transaction fees, for example. Expense calculation module 600 can also be configured to define caps and floors for a given fee. When the calculation engine of expense calculation module 600 determines what a transaction charge should be, the calculation engine can be configured to compare the calculated fee to a cap or floor value. For a cap, the calculated fee may be decreased if it is over a capped value, and for a floor, the calculated fee may be increased to meet the floor.

The rules stored in rules database 614 and accessed by expense server 606 may indicate a certain fee that should be applied to a transaction involving a specific legal entity and of a specific deal type. One rule may indicate that a brokerage expense should be raised, another may indicate that a clearing fee, a trade agreement fee, or other fee should be raised on the transaction. Once expense calculation module 600 has determined which expenses apply to a particular transaction, the calculation engine may then determine what service is being provided, who the vendor is that is providing the service, and how much the service costs. A vendor may have multiple execution services, all of which have a brokerage or other fee associated with them. These fees may be defined in a rate schedule. In one exemplary embodiment, expense module 600 is configured to automatically receive updated rate schedules from a third-party vendor. Rate schedules may have an effective data and an expiry date. As vendors change their prices, their rate schedules can be changed to reflect the new price. In addition, a vendor may negotiate directly with a bank or other financial institution to determine the rate schedule that should be applied for the bank or financial institution when interacting with the vendor. Expense calculation module 600, and EXCALIBUR in general, can be configured to automatically determine changes in rate schedules and incorporate these changes into rules database 614. Alternatively, a user may also input changes to the rules directly into the expense calculation module through user interface 608.

Once calculated, all of the expenses 628 associated with a given financial transaction may be stored in an expense database 630, which can then be made available to other modules and components within EXCALIBUR. In this way, the calculation engine of expense calculation module 600 is able to establish a data warehouse of enriched transactional data with execution costs. The expense calculation engine may also be configured to replicate vendor pricing structures for each service used to produce securities transactions enriched with transactional cost information, provide eXtensible Markup Language (XML) rate extract facility, and provide integrated exception facility and data mapping for managing source data.

The structure of expense calculation module 600 allows EXCALIBUR to accurately accrue expenses based on an internally calculated record of cost, allocate expenses based on actual service utilization, and enables businesses to offer cost-plus pricing. This structure also allows EXCALIBUR to assess trading profitability net of execution costs, identify cost ineffective executions and develop complex saving strategies. The XML rate extract functionality allows rates to be disseminated to clients or internally in a structured format for systematic update.

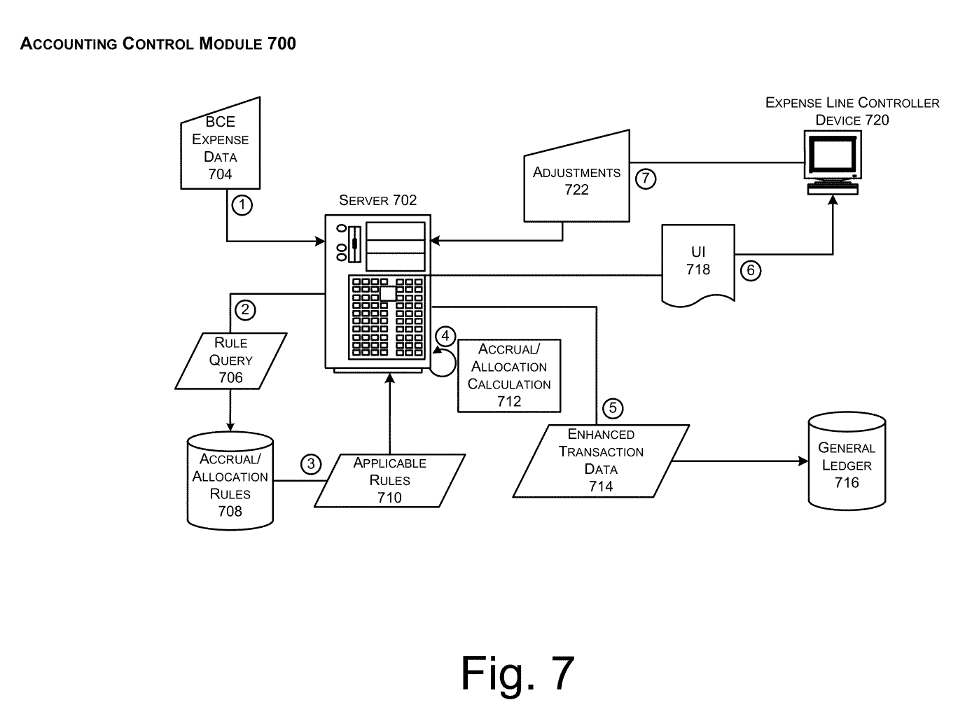

FIG. 7 is a data flow diagram illustrating an exemplary embodiment of an accounting control module 700 that may form a part of EXCALIBUR. Accounting control module 700 may be implemented using any suitable combination of hardware and software. Accounting control module 700 may include a rules-based accounting engine which performs accrual and allocation functions. Accounting control module 700 takes in sets of expense data, aggregates the data, applies accounting rules to the data in a systematic way to determine how those expenses should be apportioned to different businesses and how those expenses should manifest themselves in the general ledger of a business. It can create a payable record for expenses on the balance sheet of a company, and it can apply rules to determine which corresponding expense account, or even contra-revenue account, an expense should post in.

Accounting control module 700 may provide a rules-based expense controlling console for reviewing, adjusting, allocating, and approving accruals and accounting adjustments. It may include a calculation engine for calculating monthly accruals based on historically observed values, and may also include a rules-based allocation engine for distributing fixed and variable costs to business units. Accounting control module may also include a feature set for processing large, historical adjustments such as expense reclassification and reallocation. Accounting control module 700 may also provide transparency to effectively control a large volume of accounting entries, provide automated tools allowing for high productivity while consistently applying accounting policy, cost sharing agreements, an variable expense allocations. It may include role-base entitlements to ensure review and approval of all rules and adjustments, and it may establish an audit trail for all decisions regarding adjustments, allocations, or the application of changes in accounting policy.

As shown in FIG. 7, accounting control module 700 may include an accounting server 702, which receives expense data 704. Expense data 704 may originate from any suitable source. In one exemplary embodiment, accounting control module 700 interfaces with an expense calculation module 600, as described above. However, accounting control module may receive expense data from other external sources instead of, or in addition to, data received from expense calculation module 600. In one exemplary embodiment, accounting control module 700 may operate as a stand-alone module, in which case a user would need to provide input into the module, using, for example, a flat file or a spreadsheet file. Expense data 704 may include data relating to BCE fees for individual transactions. For each transaction, accounting server 702 may send a query 706 to an accrual and allocation rules database 708. In reply to query 706, accounting server 702 may receive the accrual and allocation rules 710 that are applicable to the specified transaction.

Once accounting server 702 has received applicable rules 710, those rules accounting server 702 may perform an accrual/allocation calculation process 712 using an accounting calculation engine. In addition to applicable rules 710 and the expense data 704, the accounting calculation engine may use additional data gleaned from other databases, including reference database 616, BCE expense database 630, and rules database 614, as well as other external databases. In one exemplary embodiment, the accounting calculation engine calculates expense accrual for a calendar month for a given fee type based on historical actual expense observations. Once the accrual/allocation calculation 712 is complete, the resulting enhanced transaction data 714 can be sent to a general ledger database 716 where it can be accesses by the general ledger system.

In this way, accounting control module 700 interfaces with the general ledger system, which may be operated by an accounting professional, such as an expense line controller, or by another user. As shown in FIG. 7, an expense line controller device 720 may be used to access accounting control module 700 through a user interface 718 served from accounting server 702. Using interface 718 on expense line controller device 720, the expense line controller may be able to provide adjustments 722 and other inputs that may have an effect on the accrual/allocation calculation process 712. Expense line controller device 720 may also interface with the general ledger system. This allows the expense line controller, or other accounting professional, to create accounting rules, general ledger mapping rules, and recurring accrual rules. The input 722 provided through the expense line controller device 720 could then be integrated into the accrual and allocation rules stored in accrual/allocation rules database 708.

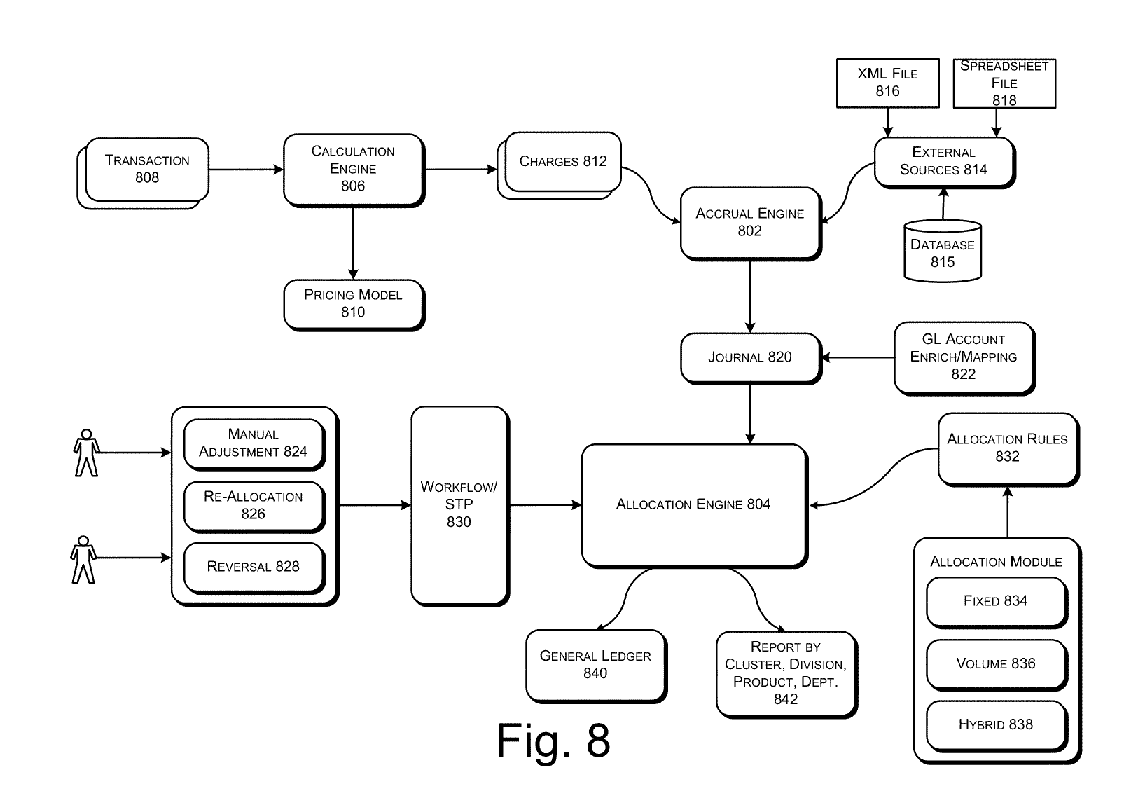

FIG. 8 is a conceptual flow diagram showing an exemplary embodiment of the operation of accounting control module 700. As shown in the diagram, accounting control module 700 may include an accrual engine 802 and an allocation engine 804. In one exemplary embodiment, these engines may run on a single server, such as accounting server 702. In another exemplary embodiment, accrual engine 802 and allocation engine 804 may run separately on distinct hardware.

A calculation engine 806, as described above with regard to expense calculation module 600, can be used to provide input for accrual engine 802. In this case, calculation engine 806 receives transaction data 808 and reference data 810, and calculates the charges or expenses 812 that should be applied to each transaction. This expense data 812 may then serve as an input to accrual engine 802. Accrual engine 802 can also receive external data 814, for example in the form of a spreadsheet file 816 or a structured data file 818. Accrual engine 802 may also received external data 814 from an external databases 815.

Accrual engine 802 may then turn the data received into journals 820, which may be defined as a summarized unit of work that can be evaluated by allocation engine 804. An expense line operator or other user can modify journals 820 using a general ledger account mapping and enriching interface 822. This allows the user to define how all of the inputs should be summarized into the allocation engine. This helps the user understand whether the expenses are directionally correct, whether the expenses conform to the historical volume and amount expected for the expenses, whether the expenses are distributed in a way that is fair and equitable, whether the expenses have incorporated all of the accounting policies that may have come top-down from the company, and whether the expenses are being redirected based on agreements that have may have been established by different businesses within the company.

In addition to providing general ledger account mapping and enrichment 822, accounting control module 700 may include additional tools that can be made available to the expense line controller or to other users. These tools include manual adjustment tools 824, which provides a user interface allowing the user to manually adjust an expense once the expense has been introduced into accounting control module 700; a reallocation tool 826 which provides a user interface allowing the user to reallocate expenses between business after the expense has been received by accounting control module 700; and a reversal tool 828, which permits a user to create an offsetting entry to an existing accrual that has already been posted to the general ledger, which effectively neutralizes the transaction. Each of these tools may interact directly with allocation engine 804, or with other portions of EXCALIBUR through a straight-through-processing interface 830.

In addition to the journals 820 received from accrual engine 802 and the adjustments made by a user through interface 830, allocation engine 804 may also receive allocation rules 832 as input. These rules may be stored in an accrual/allocation rules database as described above, and may include at least three types of rules: fixed percentage allocation rules 834, volumetric allocation rules, 836 and hybrid allocation rules 838. For a fixed-percentage allocation, a fixed percentage of the expense is applied to each business unit to be charged. In a hybrid allocation, a fixed dollar amount may be combined with a fixed percentage. In a volumetric allocation, the allocation engine may determine allocation from an external set of data. Once these rules have been applied to each transaction by allocation engine 804, the transactional records flow through the to general ledger 840. Accrual engine 804 may also be capable of producing reports 842, based on the results of the accrual calculations.

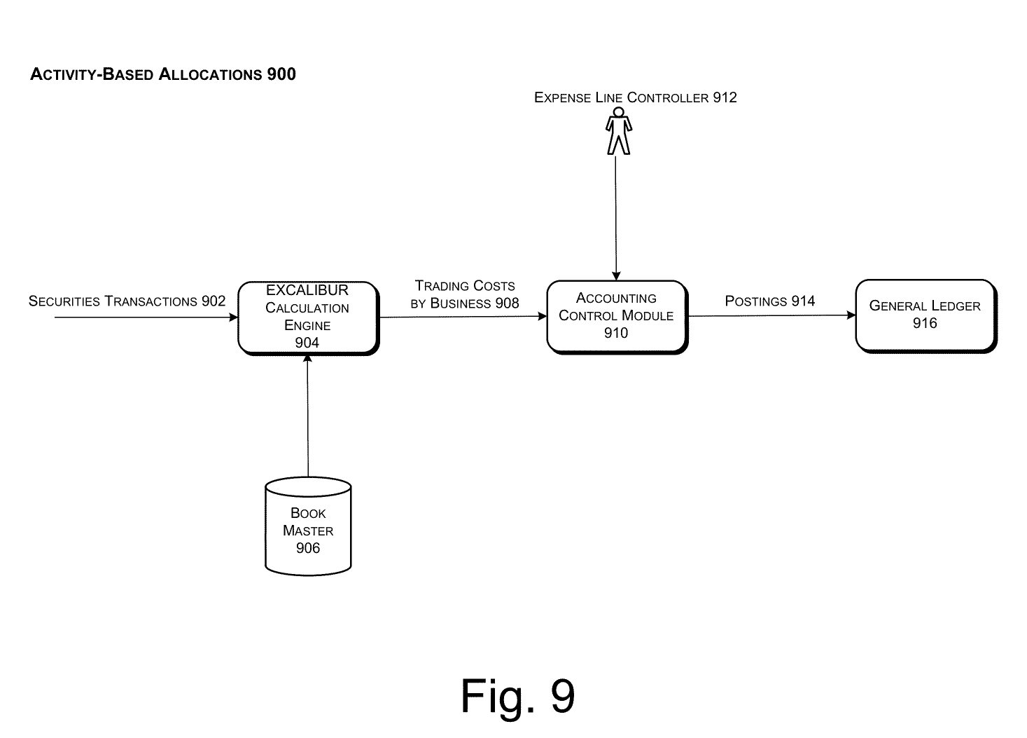

FIG. 9 is a conceptual flow diagram showing an exemplary embodiment of activity-based allocations 900 that may be effectuated by an accounting control module of EXCALIBUR. Activity-based allocations may be based on expense produced by an EXCALIBUR calculation engine, such as the calculation engine described above in conjunction with FIG. 6. Activity-based allocations may be one of the primary ways that allocations get applied for variable expenses. As shown in the figure, securities transaction data 902, for example from an external data feed, may be input into calculation engine 904. The business may be identified by the trading book 906, and the trading costs by business 908 may then be passed to the accounting control module 910, where accounting rules are applied and adjustments may be made by expense line controller 912. Postings 914 are then generated and posted to the applicable business based on the transactional-level record and the trading book. These posting 914 then flow through to the general ledger 916.

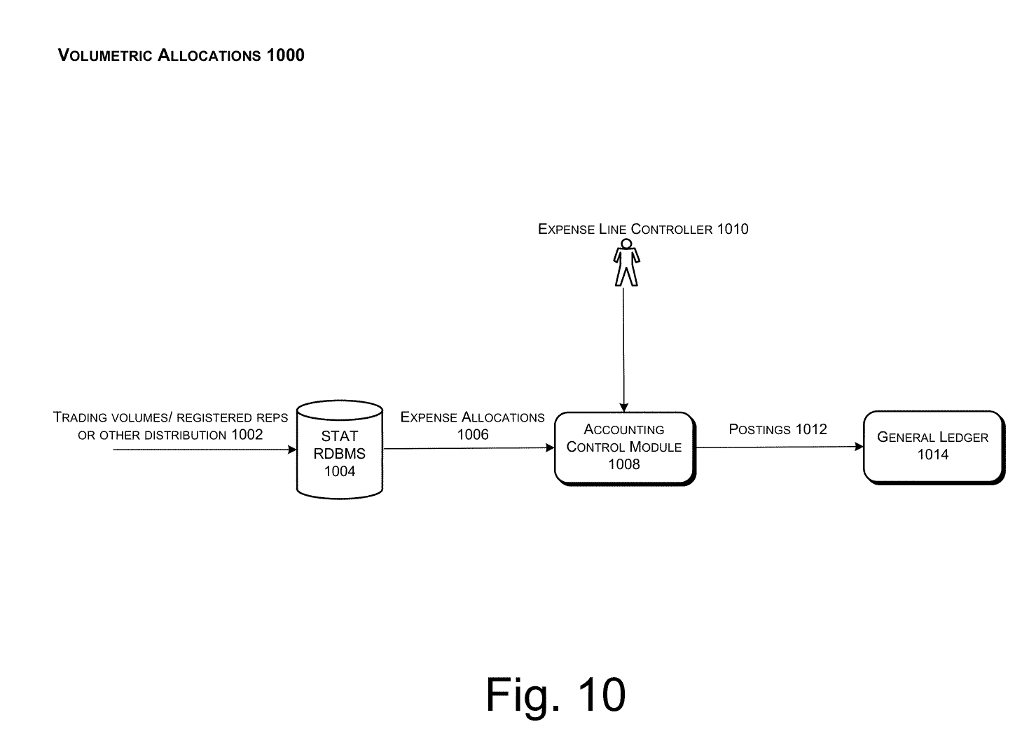

FIG. 10 is a conceptual flow diagram showing an exemplary embodiment of volumetric allocations 1000 that may be effectuated by an accounting control module of EXCALIBUR. Volumetric allocations may be based on external statistics such as trading volumes, number of registered representatives, or any other type of distribution that can be accessed by EXCALIBUR. The distribution can be any distribution, even from an external source. As long as EXCALIBUR is able to connect to a database, it can create a distribution based on the statistics in the database. As shown in FIG. 10, a distribution 1002 is passed to a statistics database 1004. Expense allocations 1006, created from database 1004, are then pulled into the accounting control module 1008. Adjustments can be applied by expense line controller 1010, and the statistic can be applied to the accruals for a given period. Postings 1012 based on these accruals are then generated, which flow through to the general ledger 1014.

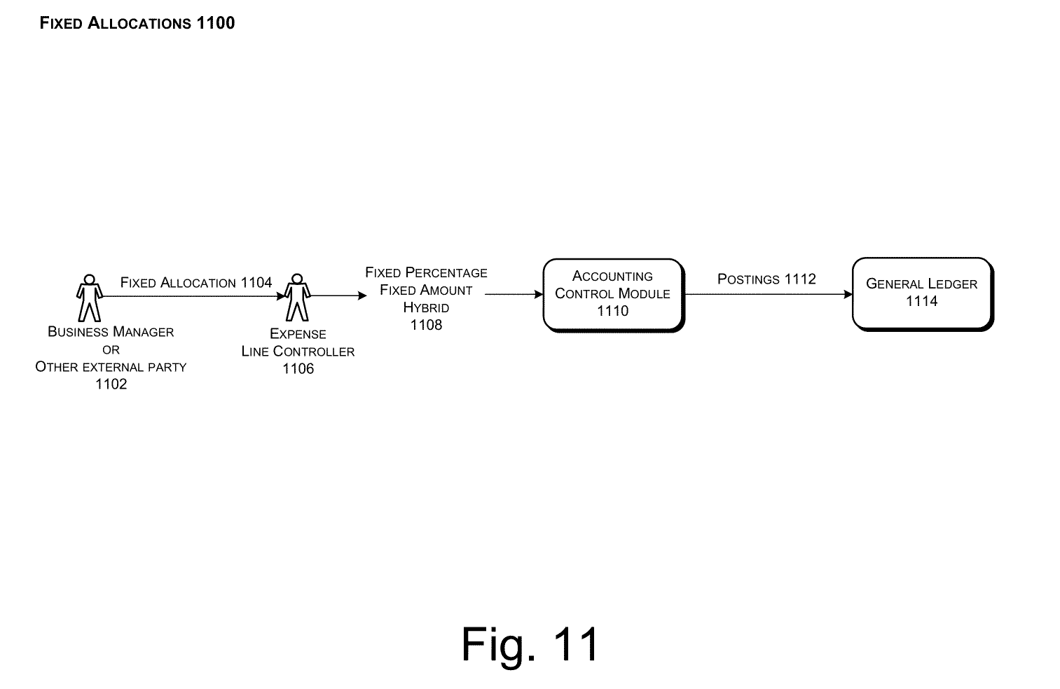

FIG. 11 is a conceptual flow diagram showing an exemplary embodiment of fixed allocations 1100 that may be effectuated by an accounting control module of EXCALIBUR. Fixed allocations are based on a static allocation—both static percentages and static amounts as well as a combination of both (a hybrid allocation) may be supported in EXCALIBUR. For example, a fixed percentage allocation rule might specify that 50% of a given expense should be allocated to Department A and 50% should be allocated to Department B. A Fixed amount allocation rule might specify that $25,000 in fees should be allocated to Department B. And a hybrid allocation rule might specify that the first $25,000 in fees should be allocated to department A, which the remaining balance, if any, should be allocated evenly to Departments B, C, and D. As shown in FIG. 11, these types of allocations might originate from a business manager or other external party 1102 and may be reviewed by an expense line controller 1106. The expense accrual rule 1108 is then passed to accounting control module 1110, which determines which rules to apply and then creates postings 1112, which are then passed to general ledger 1114.

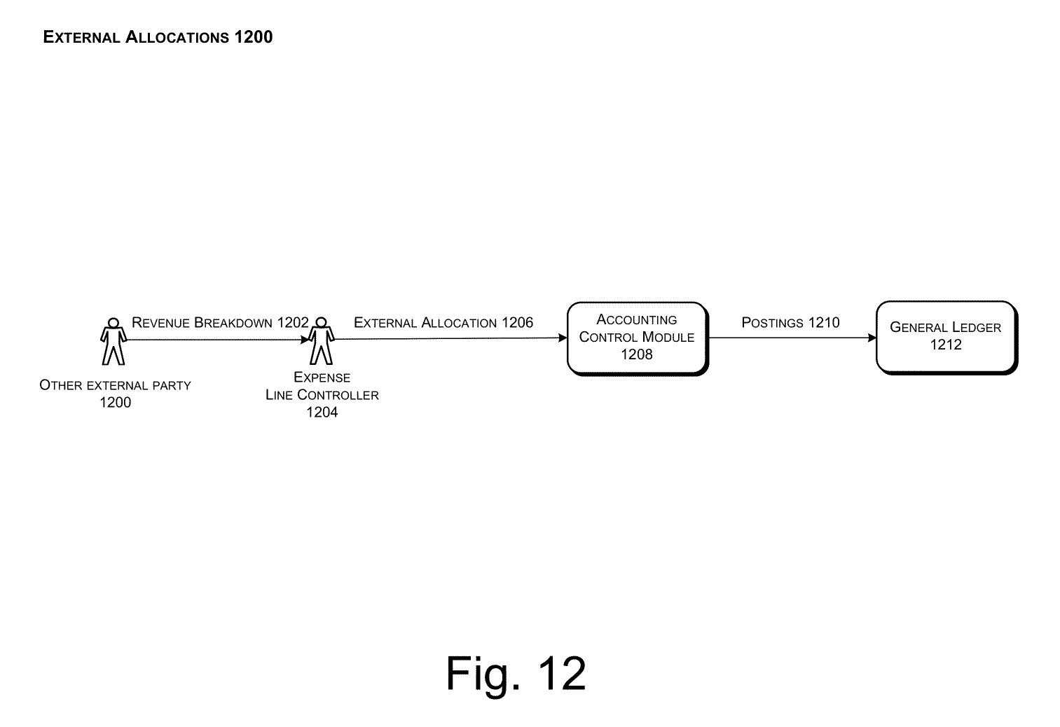

FIG. 12 is a conceptual flow diagram showing an exemplary embodiment of external allocations 1200 that may be effectuated by an accounting control module of EXCALIBUR. External allocations may include data that is not received as input from the calculation engine of EXCALIBUR. For example, there are certain regulatory fees that are based on revenues, and revenues may not be an input into the calculation engine of EXCALIBUR. In such a case, the external data may be input directly into the accounting control module of EXCALIBUR. For example, as shown in FIG. 12, in the case of regulatory fees, a regulatory control team of a company or other external party 1200 may produce a breakdown of revenue 1202 by business within the company. That information can then be passed to the expense line controller 1204, who loads the external allocation 1206 into the accounting control module 1208. The accounting control module 1208 can then apply the regulatory fee to the accrual, which will manifest itself in the postings 1210, which also flows through to the general ledger 1212.

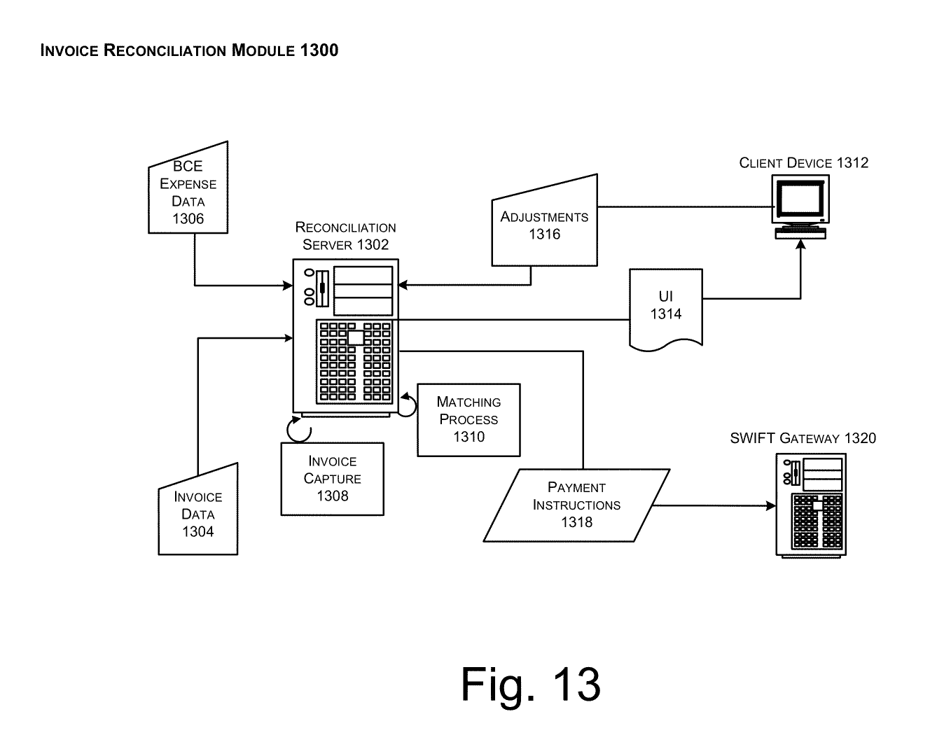

FIG. 13 is a data flow diagram illustrating an exemplary embodiment of an invoice reconciliation module 1300 that may form a part of EXCALIBUR. Invoice reconciliation module 1300 may be implemented using any suitable combination of hardware and software. Invoice reconciliation module 1300 may provide a highly flexible invoice mapping facility that allows disparate invoices to be broken down into summary or detail components for efficient capture and reconciliation. Invoice reconciliation module 1300 may including a matching engine that automates entries to adjust accruals to an invoice, and may also include an SSI (Standard Settlement Instructions) repository for automation of vendor wire payments. Invoice reconciliation module 1300 may also include an upload facility for capture of invoice details through Microsoft Excel or other suitable programs. Invoice reconciliation module 1300 may also include integrated workflow for review and approval of invoices and accounting adjustments.

Invoice reconciliation module 1300 serves to reduce costs through the identification of billed expenses that do not adhere to pricing agreements, improve invoice processing productivity through high-speed capture of invoice details through the screen or via upload, reconcile service provider bills at the invoice lien item level or at the summary level, confine adjustments between billed expenses and accruals to only business that utilized that service, and effect payments to service providers directly from the invoice reconciliation facility via SWIFT.

Invoice reconciliation module 1300 may be configured to work in conjunction with a rules-based matching engine, as described above to support complex matching iteration and minimize user intervention. Invoice reconciliation module 1300 may also be configured to completely automate invoice reconciliation and payment, and may also be configured to support different brokerage and billing currency.

In one exemplary embodiment, invoice reconciliation module 1300 includes three main components: a capture component, a reconciliation component, and a payment component. The capture component captures information from a vendor invoice to determine the BCE expenses that the vendor is billing for. The reconciliation component takes the capture invoice and compares that invoice with the internal record, for example, an internal record generated by a expense calculation module of EXCALIBUR. Once the invoice has been reconciled, submitted, and approved, the payment component disperses funds to the vendor, by initiating a SWIFT payment, a direct debit payment, or any other suitable payment.

As shown in FIG. 13, invoice reconciliation module 1300 may include a reconciliation server 1302 configured to receive invoice data 1304 and expense data 1306. Invoice data 1304 may be in any suitable form. In one exemplary embodiment, invoice data is received by server 1302 as a PDF (portable document format). In another exemplary embodiment, invoice data 1304 may be a Microsoft Excel file or other suitable spreadsheet file. In yet another exemplary embodiment, invoice reconciliation module may include a user interface that allows an operator to input data from an invoice directly into EXCALIBUR.

Once invoice data 1304 has been received or entered, reconciliation server 1302 may perform an invoice capture process 1308. When invoice data 1304 is uploaded as a spreadsheet file or other structured file, this process may include simply loading the file and saving it to an appropriate database. When invoice data 1304 is in PDF form, invoice capture process 1308 may include scanning the invoice and performing an optical character recognition (OCR) on the PDF document to extract data in a usable form.

Invoice reconciliation module 1300 may support both transaction-level invoice reconciliation and summary invoice reconciliation. Transaction-level invoice reconciliation is reconciliation of line-item details on an invoice for a financial transaction. For example, individual transaction fees that are typically listed on an invoice such as “Spot Executions,” and “Swap executions under 1 month,” are line-item details that can be reconciled using invoice reconciliation module 1300 of EXCALIBUR. Transaction details for these line items, as well as the corresponding fees can be loaded into invoice reconciliation module 1300 during invoice capture process 1308. Summary invoice reconciliation is reconciliation of the aggregate record of an underlying transaction. In this case, the line-item detail may provide the units billed, the rate, and the line item charge. For example, a total or subtotal shown on an invoice may be a line item on which summary invoice reconciliation could be performed.

When invoice capture process 1308 has been completed, reconciliation server may then perform a matching process 1310. During matching process 1310, reconciliation server 1302 may use a matching engine to compare expense data 1306 with invoice data 1304 to determine whether there are any variances between what a vendor was expected to charge and what the vendor actually charged. Invoice reconciliation module 1300 may also be accessed using a client device 1312 configured to access invoice reconciliation module 1300 through a user interface 1314. Using client device 1312, a user may be able to submit adjustments 1316 to invoice data 1304, review the invoice data, review and approve reconciled data, resolve discrepancies, submit invoices for payment, and approve invoices for payment. Because invoice reconciliation module 1300 is configured to conduct both transaction-level invoice reconciliation and summary invoice reconciliation, a user may also submit a partially reconciled invoice for partial payment.

If the matching engine finds a perfect match between the invoice data 1304 and the internal expense data 1306, the user interface of invoice reconciliation module 1300 may display a status of “Agreed.” If there is a mismatch only in brokerage amount and the rest of the fields match, then the user interface may indicate that the status of this transaction is “Reconciled.” If there is no match found, the status may be labeled as “Unreconciled.”

When discrepancies exist between internal expense data 1306 and invoice data 1304, invoice reconciliation module 1300 may provide a variety of tools and user interfaces that allow a user to resolve the discrepancies. For example, if the status of the transaction is “Reconciled,” the user interface may be configured to allow the user to adjust the agreed amount to make it manually agree so that the invoice can be paid.

Once invoice data has been reconciled, submitted for payment, and approved for payment, invoice reconciliation module 1300 may be configured to initiate actual disbursement of funds to the vendor to satisfy the invoice. Transactions which are in “Agreed” status, that is, transaction that have been perfectly matched, may be eligible for payment. In one exemplary embodiment, payment may be triggered through the user interface, which causes payment instructions 1318 to be sent to a SWIFT gateway 1320, or to any other suitable payment system.

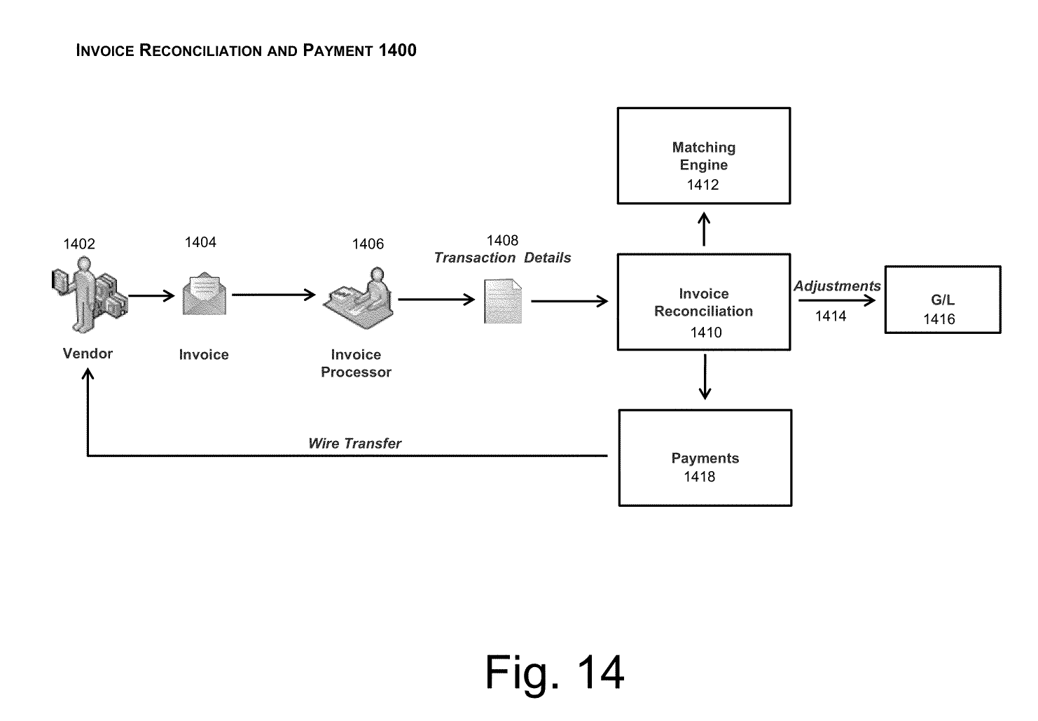

FIG. 14 is a conceptual flow diagram illustrating an invoice reconciliation and payment process 1400 that may use invoice reconciliation module 1300. First, a vendor 1402 submits an invoice 1404 to a customer such as a bank or other financial institution. The invoice is processed by an invoice processor 1406. In some cases, invoice processor 1406 would be invoice reconciliation module 1300 operating without any user intervention, but could also include a user operating interacting with reconciliation module 1300 through a user interface. The result of the invoice being processed are transactions details 1408, which are then sent to an invoice reconciliation module 1410, which also includes a matching engine 1412. Matching engine 1412 compares transaction details 1408 to the internal data for a given transaction to determine if any adjustments 1414 need to be made. These adjustments will then flow through to the general ledger 1416. Once all necessary adjustments have been made, payment 1418 to satisfy the invoice is initiated by the invoice reconciliation module and sent to vendor 1402 to satisfy invoice 1404.

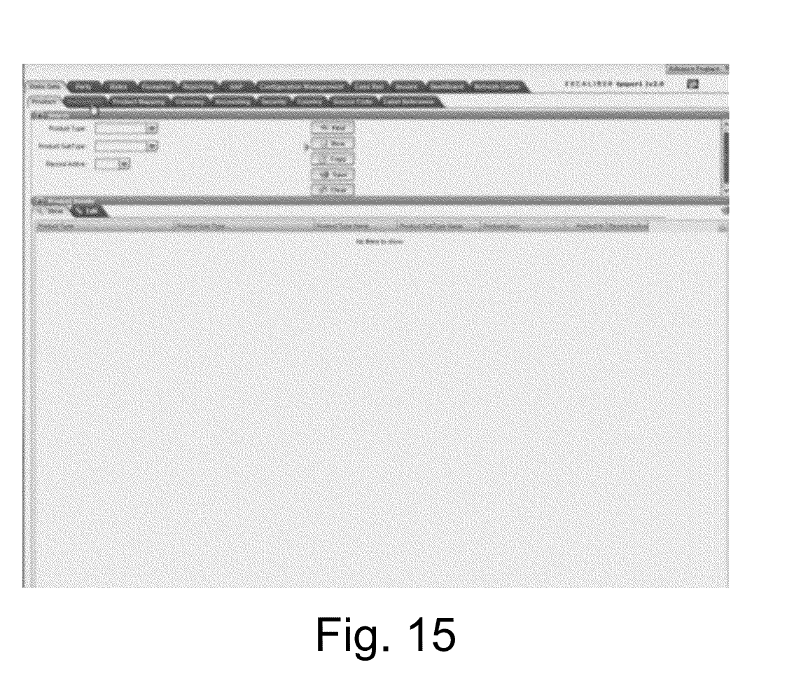

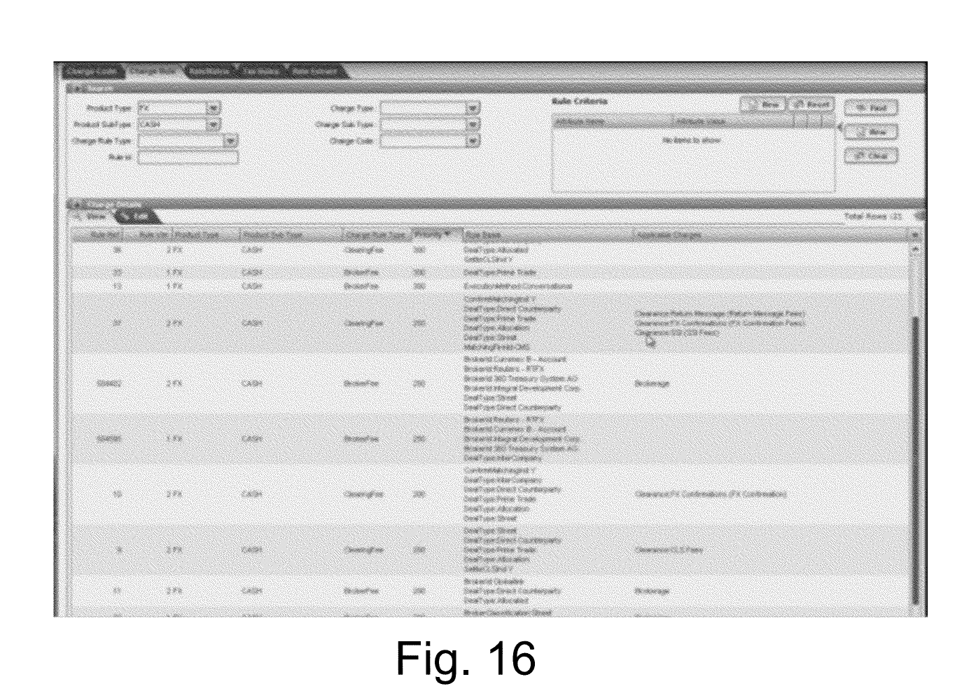

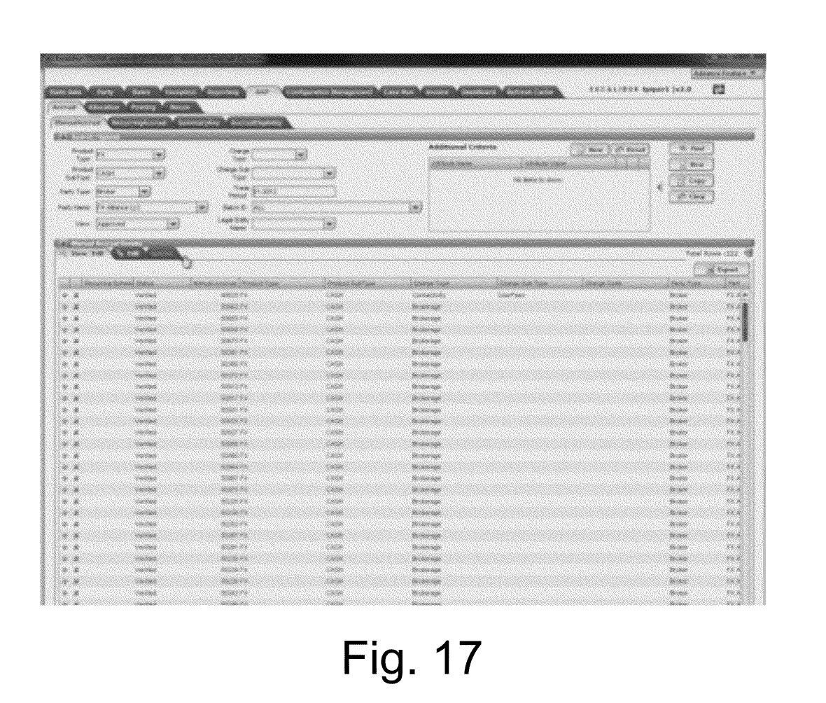

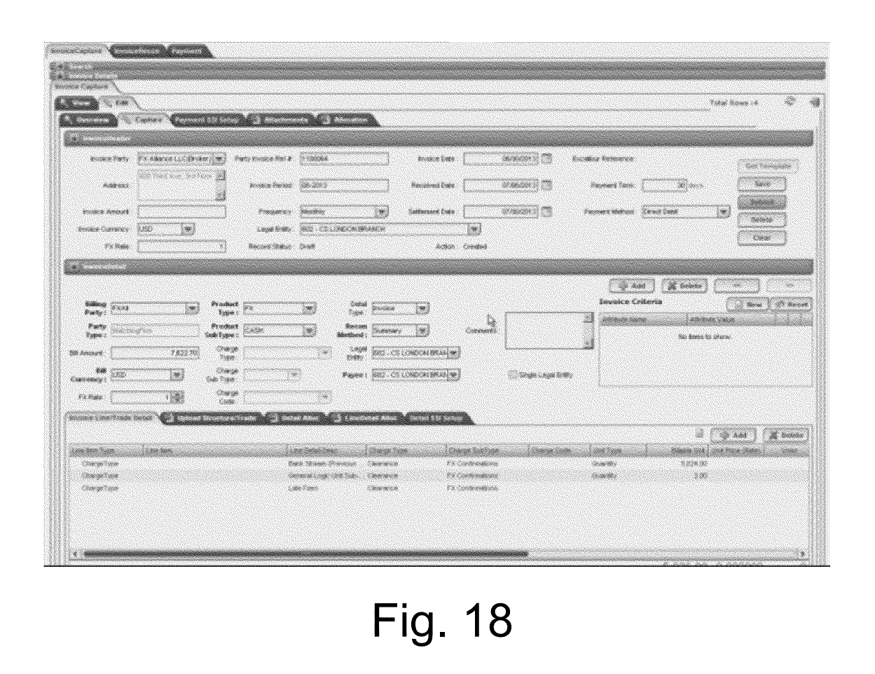

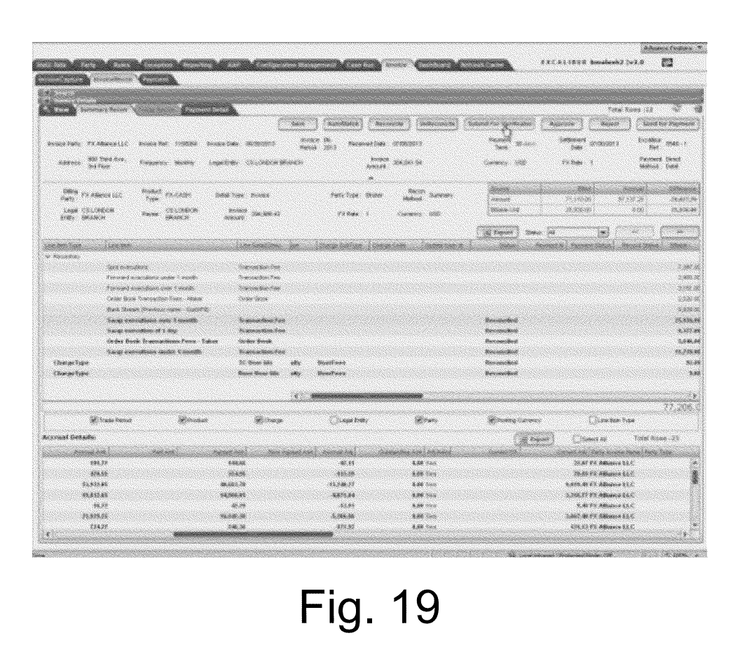

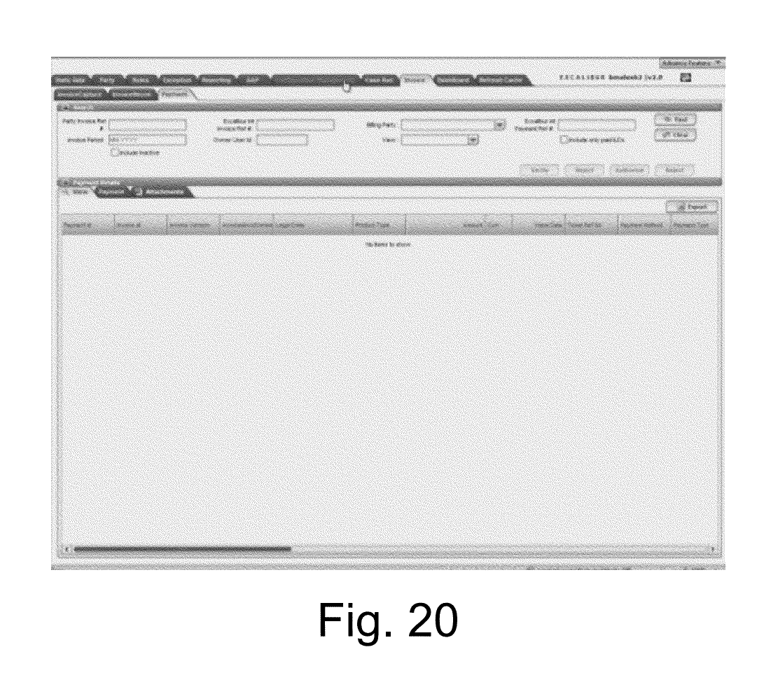

FIGS. 15-20 show portions of an exemplary embodiment of a user interface that may form a part of EXCALIBUR. FIG. 15 shows an initial screen that user might see when operating the user interface. FIG. 16 shows a portion of the user interface that may be used to interact with an expense calculation module of EXCALIBUR, for example, by editing charge rules, key-value pairs, and other attributes. FIG. 17 shows a portion of a user interface that may be used to interact with an accounting control module of EXCALIBUR. For example, a user might be able to edit accrual, allocation, and other rules from this interface. FIGS. 18, 19, and 20 show portions of a user interface that may be used to interact with an invoice reconciliation module of EXCALIBUR. FIG. 18 shows a data capture component of the invoice reconciliation module; FIG. 19 shows a reconciliation component of the invoice reconciliation module; and FIG. 20 shows a payment component of the invoice reconciliation module. The user interfaces shown in FIGS. 15-20 are merely exemplary. EXCALIBUR could be configured to operate using any other suitable user interface.

### EXCALIBUR Controller

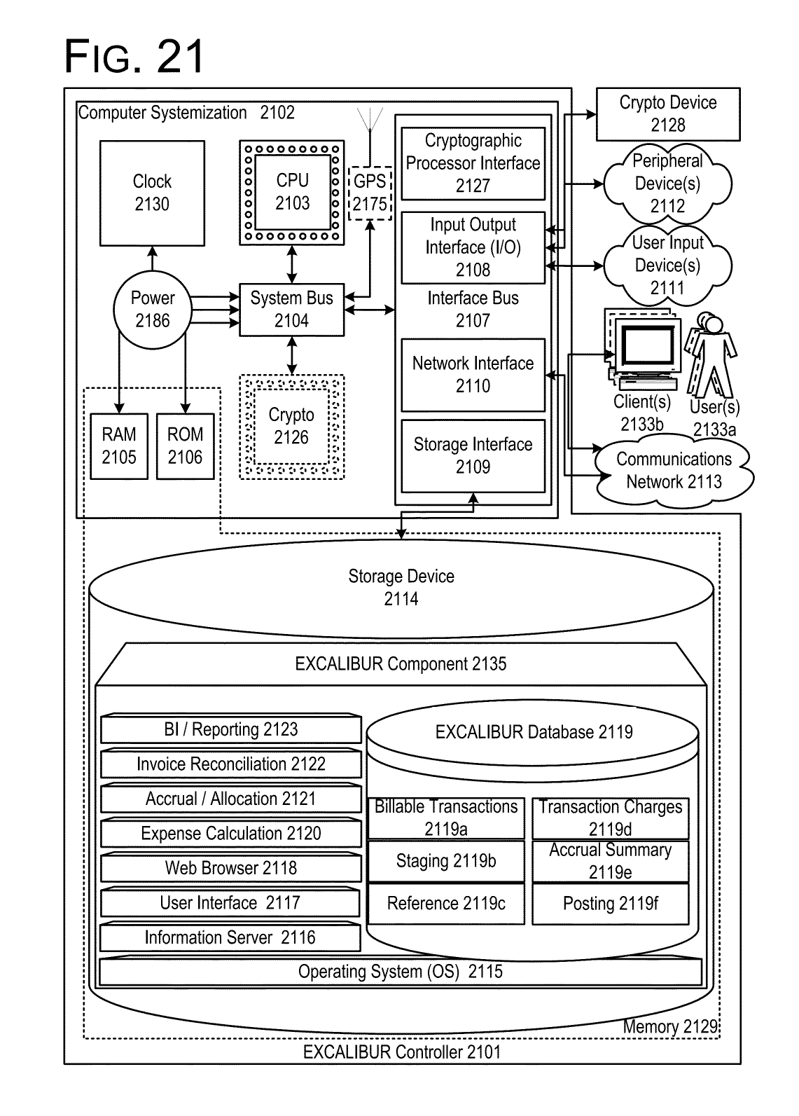

FIG. 21 illustrates inventive aspects of a EXCALIBUR controller 2101 in a block diagram. In this embodiment, the EXCALIBUR controller 2101 may serve to aggregate, process, store, search, serve, identify, instruct, generate, match, and/or facilitate interactions with a computer through expense calculation, accrual, allocation, and reconciliation technologies, and/or other related data.

Typically, users, which may be people and/or other systems, may engage information technology systems (e.g., computers) to facilitate information processing. In turn, computers employ processors to process information; such processors 2103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the EXCALIBUR controller 2101 may be connected to and/or communicate with entities such as, but not limited to: one or more users from user input devices 2111; peripheral devices 2112; an optional cryptographic processor device 2128; and/or a communications network 2113.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The EXCALIBUR controller 2101 may be based on computer systems that may comprise, but are not limited to, components such as: a computer systemization 2102 connected to memory 2129.

### Computer Systemization

A computer systemization 2102 may comprise a clock 2130, central processing unit (“CPU(s)” and/or “processor(s)” (these terms are used interchangeable throughout the disclosure unless noted to the contrary)) 2103, a memory 2129 (e.g., a read only memory (ROM) 2106, a random access memory (RAM) 2105, etc.), and/or an interface bus 2107, and most frequently, although not necessarily, are all interconnected and/or communicating through a system bus 2104 on one or more (mother)board(s) 2102 having conductive and/or otherwise transportive circuit pathways through which instructions (e.g., binary encoded signals) may travel to effect communications, operations, storage, etc. Optionally, the computer systemization may be connected to an internal power source 2186. Optionally, a cryptographic processor 2126 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2129 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the EXCALIBUR controller and beyond through various interfaces. Should processing requirements dictate a greater amount speed and/or capacity, distributed processors (e.g., Distributed EXCALIBUR), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the EXCALIBUR may be achieved by implementing a microcontroller such as CAST's R8051XC2 microcontroller; Intel's MCS 51 (i.e., 8051 microcontroller); and/or the like. Also, to implement certain features of the EXCALIBUR, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the EXCALIBUR component collection (distributed or otherwise) and/or features may be implemented via the microprocessor and/or via embedded components; e.g., via ASIC, coprocessor, DSP, FPGA, and/or the like. Alternately, some implementations of the EXCALIBUR may be implemented with embedded components that are configured and used to achieve a variety of features or signal processing.

Depending on the particular implementation, the embedded components may include software solutions, hardware solutions, and/or some combination of both hardware/software solutions. For example, EXCALIBUR features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the EXCALIBUR features. A hierarchy of programmable interconnects allow logic blocks to be interconnected as needed by the EXCALIBUR system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the EXCALIBUR may be developed on regular FPGAs and then migrated into a fixed version that more resembles ASIC implementations. Alternate or coordinating implementations may migrate EXCALIBUR controller features to a final ASIC instead of or in addition to FPGAs. Depending on the implementation all of the aforementioned embedded components and microprocessors may be considered the “CPU” and/or “processor” for the EXCALIBUR.

### Power Source

The power source 2186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2186 is connected to at least one of the interconnected subsequent components of the EXCALIBUR thereby providing an electric current to all subsequent components. In one example, the power source 2186 is connected to the system bus component 2104. In an alternative embodiment, an outside power source 2186 is provided through a connection across the I/O 2108 interface. For example, a USB and/or IEEE 1394 connection carries both data and power across the connection and is therefore a suitable source of power.

### Interface Adapters

Interface bus(ses) 2107 may accept, connect, and/or communicate to a number of interface adapters, conventionally although not necessarily in the form of adapter cards, such as but not limited to: input output interfaces (I/O) 2108, storage interfaces 2109, network interfaces 2110, and/or the like. Optionally, cryptographic processor interfaces 2127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2109 may accept, communicate, and/or connect to a number of storage devices such as, but not limited to: storage devices 2114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2110 may accept, communicate, and/or connect to a communications network 2113. Through a communications network 2113, the EXCALIBUR controller is accessible through remote clients 2133b (e.g., computers with web browsers) by users 2133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed EXCALIBUR), architectures may similarly be employed to pool, load balance, and/or otherwise increase the communicative bandwidth required by the EXCALIBUR controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2110 may be used to engage with various communications network types 2113. For example, multiple network interfaces may be employed to allow for the communication over broadcast, multicast, and/or unicast networks.

Input Output interfaces (I/O) 2108 may accept, communicate, and/or connect to user input devices 2111, peripheral devices 2112, cryptographic processor devices 2128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2111 may be card readers, dongles, finger print readers, gloves, graphics tablets, joysticks, keyboards, mouse (mice), remote controls, retina readers, trackballs, trackpads, and/or the like.

Peripheral devices 2112 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the EXCALIBUR controller may be embodied as an embedded, dedicated, and/or monitor-less (i.e., headless) device, wherein access would be provided over a network interface connection.

Cryptographic units such as, but not limited to, microcontrollers, processors 2126, interfaces 2127, and/or devices 2128 may be attached, and/or communicate with the EXCALIBUR controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2129. However, memory is a fungible technology and resource, thus, any number of memory embodiments may be employed in lieu of or in concert with one another. It is to be understood that the EXCALIBUR controller and/or a computer systemization may employ various forms of memory 2129. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 2129 will include ROM 2106, RAM 2105, and a storage device 2114. A storage device 2114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2129 may contain a collection of program and/or database components and/or data such as, but not limited to: operating system component(s) 2115 (operating system); information server component(s) 2116 (information server); user interface component(s) 2117 (user interface); Web browser component(s) 2118 (Web browser); database(s) 2119; mail server component(s); mail client component(s); cryptographic server component(s) (cryptographic server); expense calculation component(s) 2120; accrual/allocation component(s) 2121; invoice reconciliation component(s) 2122); business intelligence/reporting component(s) 2123; the EXCALIBUR component(s) 2135; and/or the like (i.e., collectively a component collection). These components may be stored and accessed from the storage devices and/or from storage devices accessible through an interface bus. Although non-conventional program components such as those in the component collection, typically, are stored in a local storage device 2114, they may also be loaded and/or stored in memory such as: peripheral devices, RAM, remote storage facilities through a communications network, ROM, various forms of memory, and/or the like.

### Operating System

The operating system component 2115 is an executable program component facilitating the operation of the EXCALIBUR controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the EXCALIBUR controller to communicate with other entities through a communications network 2113. Various communication protocols may be used by the EXCALIBUR controller as a subcarrier transport mechanism for interaction, such as, but not limited to: multicast, TCP/IP, UDP, unicast, and/or the like.

### Information Server

An information server component 2116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the EXCALIBUR controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the EXCALIBUR database 2119, operating systems, other program components, user interfaces, Web browsers, and/or the like.

Access to the EXCALIBUR database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the EXCALIBUR. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the EXCALIBUR as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 2117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the EXCALIBUR enabled nodes. The combined application may be nugatory on systems employing standard Web browsers.

### Mail Server

A mail server component 2121 is a stored program component that is executed by a CPU 2103. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the EXCALIBUR.

Access to the EXCALIBUR mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component is a stored program component that is executed by a CPU 2103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POPS, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component is a stored program component that is executed by a CPU 2103, cryptographic processor 2126, cryptographic processor interface 2127, cryptographic processor device 2128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the EXCALIBUR may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the EXCALIBUR component to engage in secure transactions if so desired. The cryptographic component facilitates the secure accessing of resources on the EXCALIBUR and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The EXCALIBUR Database

The EXCALIBUR database component 2119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the EXCALIBUR database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the EXCALIBUR database is implemented as a data-structure, the use of the EXCALIBUR database 2119 may be integrated into another component such as the EXCALIBUR component 2135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2119 includes several tables 2119a-f, including a billable_transaction table 2119a, a staging table 2119b, a reference_data table 2119c, a transaction_charge table 2119d, an accrual_summary table 2119e, and a posting table 2119f.

In one embodiment, the EXCALIBUR database may interact with other database systems. For example, employing a distributed database system, queries and data access by search EXCALIBUR component may treat the combination of the EXCALIBUR database, an integrated data security layer database as a single database entity.

In one embodiment, user programs may contain various user interface primitives, which may serve to update the EXCALIBUR. Also, various accounts may require custom database tables depending upon the environments and the types of clients the EXCALIBUR may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2119a-f. The EXCALIBUR may be configured to keep track of various settings, inputs, and parameters via database controllers.

The EXCALIBUR database may communicate to and/or with other components in a component collection, including itself, and/or facilities of the like. Most frequently, the EXCALIBUR database communicates with the EXCALIBUR component, other program components, and/or the like. The database may contain, retain, and provide information regarding other nodes and data.

### The EXCALIBURs

The EXCALIBUR component 2135 is a stored program component that is executed by a CPU. In one embodiment, the EXCALIBUR component incorporates any and/or all combinations of the aspects of the EXCALIBUR that was discussed in the previous figures. As such, the EXCALIBUR affects accessing, obtaining and the provision of information, services, transactions, and/or the like across various communications networks.

The EXCALIBUR component enables the determination of weights for constituents of index-linked financial portfolios, the acquisition and/or maintenance/management of those constituents, the determination of market values and/or returns associated with the indices, the generation of financial products based on the indices, and/or the like and use of the EXCALIBUR.

The EXCALIBUR component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the EXCALIBUR server employs a cryptographic server to encrypt and decrypt communications. The EXCALIBUR component may communicate to and/or with other components in a component collection, including itself, and/or facilities of the like. Most frequently, the EXCALIBUR component communicates with the EXCALIBUR database, operating systems, other program components, and/or the like. The EXCALIBUR may contain, communicate, generate, obtain, and/or provide program component, system, user, and/or data communications, requests, and/or responses.

### Distributed EXCALIBURs

The structure and/or operation of any of the EXCALIBUR node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the EXCALIBUR controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment. The following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

To address various issues related to, and improve upon, previous work, the application is directed to EXPENSE CALCULATION AND BUSINESS REPORTING APPARATUSES, METHODS, AND SYSTEMS. The entirety of this application (including the Cover Page, Title, Headings, Field, Background, Summary, Brief Description of the Drawings, Detailed Description, Claims, Abstract, Figures, Appendices, and any other portion of the application) shows by way of illustration various embodiments. The advantages and features disclosed are representative; they are not exhaustive or exclusive. They are presented only to assist in understanding and teaching the claimed principles. It should be understood that they are not representative of all claimed inventions. As such, certain aspects of the invention have not been discussed herein. That alternate embodiments may not have been presented for a specific portion of the invention or that further undescribed alternate embodiments may be available for a portion of the invention is not a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the invention. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functionality, features, logical aspects, organizational aspects, structural aspects, topological aspects, and other aspects of the disclosure are not to be considered limitations on the disclosure as defined by the claims or limitations on equivalents to the claims.

Depending on the particular needs and/or characteristics of a EXCALIBUR user, various embodiments of the EXCALIBUR may be implemented that enable a great deal of flexibility and customization. This disclosure discusses embodiments and/or applications of the EXCALIBUR directed to providing an end-to-end solution for managing brokerage, clearance, exchange, and other fees and may include a highly configurable rules-based calculation engine capable of calculating complex fees across a diverse set of vendors, rate schedules, and expense types. It may also include the ability to automate monthly accrual processes and provide an integrated solution for invoice validation and payment. However, it is to be understood that the apparatuses, methods and systems discussed herein may be readily adapted and/or reconfigured for a wide variety of other applications and/or implementations. Furthermore, aspects of the EXCALIBUR may be configured to generate, administer, and/or manage a wide variety of fees and expenses for different financial instruments, securities, and/or the like beyond specific embodiments and/or implementations described in detail herein. The exemplary embodiments discussed in this disclosure are not mutually exclusive and may be combined in any combination to implement the functions of EXCALIBUR. EXCALIBUR may be further adapted to other implementations and/or applications that may be unrelated to brokerage, clearance, and exchange fees.

The invention claimed is:

1. A system for expense calculation and management, the system comprising:
a processor interfacing with a memory device;
an expense calculation module configured to run on the processor, receive transaction data relating to a first transaction, and to apply at least one charge rule to the transaction data to calculate expense data detailing the expenses expected to be charged in association with the first transaction;
an invoice reconciliation module configured to run on the processor, receive as inputs the expense data as well as invoice data related to the first transaction, and to determine whether the invoice data matches the expense data for the first transaction.

2. The system of claim 1, further comprising an accounting control module configured to run on the processor, to receive the expense data as an input and to apply at least one accounting rule to the expense data to create enhanced data relating to the first transaction.

3. The system of claim 1, further comprising a data integration module configured to run on the processor and create the transaction data by receiving raw data from a plurality of data sources and applying at least one data-quality rule to normalize the raw data.

4. The system of claim 2, further comprising a user interface configured to allow a user to adjust data within the expense calculation module, the accounting control module, and the invoice reconciliation module.

5. The system of claim 1, wherein the charge rules applied by the expense calculation module include attributes stored as key-value pairs.

6. The system of claim 1, wherein the at least one charge rule applied by the expense calculation module includes a priority value.

7. The system of claim 6, wherein the expense calculation module is configured to apply a plurality of charge rules to the first transaction and to resolve charge rule conflicts based on the priority value for each charge rule.

8. The system of claim 1, wherein the expense calculation module is further configured to apply at least one of cap rules, floor rules, and running total rules to the transaction data relating to the first transaction.

9. The system of claim 2, wherein the invoice reconciliation module is further configured to interface with the accounting control module and to adjust the enhanced data.

10. The system of claim 9, wherein the enhanced data comprises accruals and the invoice reconciliation module is further configured to automatically adjust accruals within a predefined adjustment threshold.

11. The system of claim 2, wherein the accounting control module is further configured to provide the enhanced data to a general ledger system.

12. The system of claim 2, wherein the at least one accounting rule applied by the accounting control module includes an accrual rule.

13. The system of claim 2, wherein the at least one accounting rule applied by the accounting control module includes an allocation rule.

14. The system of claim 1, wherein the invoice reconciliation module is further configured to automatically initiate payment of an invoice when the invoice data matches the expense data.

15. The system of claim 1, wherein the invoice reconciliation module further comprises a invoice data capture component.

16. A processor-implemented method for expense calculation, allocation, and reconciliation, the method comprising:
receiving, using a processor, transaction data relating to a first transaction;
applying at least one charge rule to the transaction data to calculate expense data detailing the expenses expected to be charged in association with the first transaction;
receiving the expense data as an input using a processor;
applying the at least one accounting rule to the expense data to create enhanced data relating to the first transaction;
receiving as input, using a processor, the expense data as well as invoice data related to the first transaction; and
determining, using a processor, whether the invoice data matches the expense data for the first transaction.

17. The method of claim 16, further comprising creating the transaction data by receiving raw data from a plurality of data sources and applying at least one data-quality rule to normalize the raw data.

18. The method of claim 16, wherein the applying the at least one charge rule includes comparing the transaction data to charge-rule attributes stored as key-value pairs.

19. The method of claim 16, wherein applying the at least one charge rule includes applying a plurality of charge rules.

20. The method of claim 19, wherein applying the at least one charge rule includes resolving charged rule conflicts based on a priority value for each charge rule.

21. The system of claim 16, wherein the expense calculation module is further configured to apply at least one of cap rules, floor rules, and running total rules to the first transaction.

22. The method of claim 16, wherein applying at least one accounting rule comprises applying an accrual rule.

23. The method of claim 16, wherein applying at least one accounting rule comprises applying an allocation rule.

24. The method of claim 16, further comprising automatically initiating payment of and invoice when the invoice data matches the expense data.

25. A machine-readable, non-transitory tangible medium storing processor-issuable instructions to:
receive raw data from a plurality of data sources;
apply at least one data-quality rule to normalize the raw data and create transaction data;
receive transaction data relating to a first transaction;
applying at least one charge rule to the transaction data to create expense data detailing the expenses expected to be charged in association with the first transaction;
receiving the expense data as an input;
apply the at least one accounting rule to the expense data to create enhanced data relating to the first transaction;
receive as input the expense data as well as invoice data related to the first transaction; and
determine whether the invoice data matches the expense data for the first transaction.
